(19) United States
(12) Patent Application Publication
(10) Pub. No.: US 2020/0228779 A1
(43) Pub. Date: Jul. 16, 2020

(54) PROVISIONING OF DIGITAL CONTENT FOR REPRODUCTION IN A MOBILE DEVICE

(71) Applicant: ROK Mobile International Ltd., Culver City, CA (US)

(72) Inventor: Jonathan Kendrick, Culver City, CA (US)

(21) Appl. No.: 16/248,459

(22) Filed: Jan. 15, 2019

(51) Int. Cl. H04N 13/189; H04N 13/398; H04N 13/178; H04N 5/93

(52) U.S. Cl. CPC H04N 13/189; H04N 5/9305; H04N 13/178; H04N 13/398

(57) ABSTRACT

Technologies are provided to generate digital content for reproduction in mobile devices. The digital content can be provided in a memory card that includes a non-volatile memory device and processing circuitry. The digital content can be generated using a combination of source digital content accessed from a storage assembly and at least one of reproduction information or production configuration information. The reproduction information conveys one or multiple configurations for playback of the source digital content. The production configuration information conveys one or multiple satisfactory configurations for content reproduction at a mobile device. The digital content is formatted according to a defined video format and includes 3D content. In some instances, the digital content also can include 4D content, which includes 3D content and information for controlling haptic effects related to the 3D content. The digital content can be provided with digital rights management (DRM) information.

### BACKGROUND

There is a trend for mobile telephones to be provided with color displays having many thousands of pixels. As time progresses the quality of these displays and the resolutions afforded thereby tends to increase. Further, semiconductor technology is such the mobile telephones and other types of mobile devices can be provided with a range of quite substantial amounts of memory and processing speeds. Moreover, mobile devices also can be provided with sensors and haptic devices that can facilitate the interaction of an end-user with audiovisual content presented at a mobile device.

Whereas MP3 players, media consumption applications, and the like have been incorporated into mobile telephones, the provision of improved displays and increased amounts of memory and processing speed allows mobile telephones to be used as on-demand digital multimedia reproduction devices. In some cases, audiovisual content may be provided on a MultiMediaCard (MMC) card, for viewing on a mobile telephone. The Nokia™ 7610 is one such capable mobile telephone. Such a telephone can handle 3GPP and RealMedia™ audiovisual formats. The audiovisual content that is commonly consumed at mobile telephones appears to be mostly concentrated around conventional two-dimensional (2D) audiovisual content.

Further, the provision of copyright works onto MultiMediaCard (MMC) cards for sale to the public potentially provides an opportunity for the content to be illegally copied and distributed.

Therefore, much remains to be improved in the provisioning of audiovisual content for consumption in a mobile device.

### SUMMARY

The disclosure recognizes and addresses the technical issue of providing digital content for consumption on mobile devices. To that end, technologies disclosed herein permit providing digital content for reproduction in a mobile device. The digital content can be provided in a memory card that includes a non-volatile memory device and processing circuitry. The memory card can be connected to the mobile device and includes an interface that permits or otherwise facilitates the processing of the digital content by the mobile device. The digital content can be generated using a combination of source digital content accessed from a storage assembly and at least one of reproduction information or production configuration information. The reproduction information conveys playback configuration of the source digital content. The reproduction information can include, for example, a combination of an aspect ratio; a number of video channels (main content, subtitles, etc.); number of frames; video resolution; frame rate; video bitrate; audio tracks, number and/or type of audio channels, audio sampling rate, audio bitrate. The production configuration information conveys one or multiple satisfactory configurations for content reproduction at a mobile device. The production configuration information can be similar in type to the source playback information, but the production configuration information also can include other types of elements that convey hardware available for content reproduction at the mobile device. One such configuration can include, for example, a combination of at least some of a type of a display device (e.g., 2D display device or 3D display device) integrated in the mobile device; a pixel resolution of the display device; an aspect ratio; a video bitrate; an audio bitrate; number and/or type of audio channels; a video format for reproduction at the mobile device; or haptic or sensory devices present in the mobile device. The digital content is formatted according to a defined video format and includes 3D content. In some instances, the digital content also can include 4D content, which includes 3D content and information for controlling haptic effects and/or other types of sensory effects related to the 3D content. The digital content can be provided with digital rights management (DRM) information.

According to an embodiment, the disclosure provides a portable data storage non-transitory medium. The portable data storage non-transitory medium includes a non-volatile memory device. The portable data storage non-transitory medium also includes an interface including terminals for connecting to an external device. The portable data storage non-transitory medium further includes a controller device configured to read data out from the non-volatile memory device, and further configured to send the data to the interface. The portable data storage non-transitory medium still further includes a security device configured to determine whether an external device is entitled to access content data from the non-volatile memory, and to allow or disallow access to the content data accordingly.

A data terminal of the controller device can be connected to the interface via the security device.

Alternatively, the security device can be integral with the controller. In this case, the controller and security device may be operable to decrypt content data read out from the non-volatile memory.

The controller device is also configured to write data from the interface to the non-volatile memory device. In this case, if the controller and security device is operable to decrypt content data read out from the non-volatile memory, it may be operable also to encrypt data written from the interface to the non-volatile memory.

### BRIEF DESCRIPTION OF THE DRAWINGS

Embodiments of the present disclosure will now be described by way of example only, with reference to the accompanying drawings in which:

FIG. 1 presents an example of an operational environment to provision 3D content to portable chip cards, in accordance with one or more embodiments of this disclosure;

FIG. 2 presents an example of a digital content provision apparatus, in accordance with one or more embodiments of this disclosure;

FIG. 3 presents an example of a computing system to provision digital content (e.g., 3D content) to portable chip cards, in accordance with one or more embodiments of the disclosure;

FIG. 4 presents an example of an audiovisual content provision apparatus, in accordance with one or more embodiments of the disclosure;

FIG. 5 and FIG. 6 illustrate example operations of the apparatus illustrated in FIG. 4, in accordance with one or more embodiments of the disclosure;

FIG. 7 presents an example of an operational environment to provision digital content (e.g., 4D content) to portable chip cards, in accordance with one or more embodiments of this disclosure;

FIG. 8 presents an example of a computing system to provision digital content (e.g., 4D content) to portable chip cards, in accordance with one or more embodiments of the disclosure;

FIG. 9 presents an example of a method for configuring a portable chip card with digital content (e.g., 2D content, 3D content, and/or 4D content) in accordance with one or more embodiments of the disclosure;

FIG. 10 presents an example of a method for configuring information to implement haptic effects associated with digital content, in accordance with one or more embodiments of the disclosure;

FIG. 11 presents an example of a method for generating metadata to control haptic effects corresponding to 3D digital content, in accordance with one or more embodiments of the disclosure;

FIG. 12 illustrates an example of a mobile device for reproduction of digital content, in accordance with one or more embodiments of the disclosure;

FIG. 13 illustrates a combination of a portable chip card and the mobile device illustrated in FIG. 12, in accordance with one or more embodiments of the disclosure;

FIG. 14 and FIG. 15 illustrate examples of portable chip cards, according to one or more embodiments of the disclosure;

FIG. 16 illustrates an example of method for security validation between a mobile device that includes the apparatus illustrated in FIG. 12 and the portable chip cards of FIG. 14 or FIG. 15, in accordance with one or more embodiments of the disclosure;

FIG. 17 illustrates an example of a system of interconnected computers to provision digital content, in accordance with one or more embodiments of the disclosure;

FIG. 18 presents an example of a computing environment to provision digital content, in accordance with one or more embodiments of the disclosure;

FIG. 18A presents an example of a software architecture that can be executed to provision digital content in accordance with one or more embodiments of the disclosure; and

FIG. 18B presents an example of another software architecture that can be executed to provision digital content in accordance with one or more embodiments of the disclosure.

Throughout the drawings, reference numerals are reused for like elements.

### DETAILED DESCRIPTION

The technologies disclosed herein are not limited to specific systems, apparatuses, methods, specific components, or to particular implementations. Further, the terminology used herein is for the purpose of describing particular embodiments of those technologies only and the terminology is not intended to be limiting.

As is used in the specification and the annexed drawings, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described element, event, or circumstance may or may not be present or otherwise occur, and that the description includes instances where said elements, event, or circumstance is present or otherwise occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

The methods and systems disclosed herein may take the form of an entirely hardware embodiment, an entirely software embodiment, or an embodiment combining software and hardware aspects. Furthermore, the methods and systems may take the form of a computer program product on a computer-readable storage medium having machine-accessible instructions, such as computer-executable instructions (e.g., computer software), embodied in the storage medium. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general-purpose computer, special-purpose computer, or other programmable data processing apparatus to produce a machine, such that the instructions which execute on the computer or other programmable data processing apparatus create a means for implementing the functions specified in the flowchart block or blocks.

These machine-accessible instructions may also be stored in a computer-readable memory that can direct a computer or other programmable data processing apparatus to function in a particular manner, such that the instructions stored in the computer-readable memory produce an article of manufacture including machine-accessible instructions (e.g., computer-readable instructions and/or computer-executable instructions) for implementing the function specified in the flowchart block or blocks. The machine-accessible instructions may also be loaded onto a computer or other programmable data processing apparatus to cause a series of operational steps to be performed on the machine or other programmable computing apparatus to produce a computer-implemented process such that the instructions that execute on the machine or other programmable computing apparatus provide operations for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Providing audiovisual content for consumption on a mobile device currently is a laborious and time-consuming process. To address this and other technical issues, embodiments of the technologies disclosed herein include portable storage devices, apparatuses, and methods that, individually or in combination, permit providing audiovisual content for reproduction on a target mobile device which is convenient yet capable of utilizing the full capabilities of the target mobile device.

According to an embodiment, the present disclosure provides an apparatus for providing audiovisual content for reproduction on a mobile device. The apparatus includes: a first source device that provides audiovisual content; a second source device that provides target device configuration information; a codec; and a conversion module. The conversion module is arranged to use the codec to convert the audiovisual content according at least to the target device configuration information, thereby to supply mobile device consumable content data.

This can allow the automated error-free generation of audiovisual content for reproduction on mobile devices, such as mobile telephones, smartphones, smartwatches, videogame consoles, digital versatile disc (DVD) players, Blu-ray disc (BD) players, and the like. Such reproduction can be optimized for consumption by a particular mobile device. As is disclosed herein, optimization may be in respect of such characteristics as frame rate, display size (in particular aspect ratio) and audio output capabilities. Optimization may also take into account the user of the mobile device, by providing audio, and optionally subtitles, in a suitable language.

Advantageously, the apparatus can be arranged to use a) configuration information including a maximum volume size for a target storage device, and b) a detected content duration parameter to determine an appropriate respective bitrate for one or both of audio and video components, and to control the conversion module to provide converted data having the determined bitrate for the audio and/or video components. This can allow the quality of the audio and/or video components to be optimized automatically according to the content source and to the size of the destination.

The apparatus also can be arranged to determine from the target mobile device configuration information and required aspect ratio for displayed video, and to control the conversion module to modify the source audiovisual content so as to provide content having the required aspect ratio.

The apparatus can further include a digital rights management (DRM) module configured to operate with the conversion module to provide the content with data operable to restrict content playback.

In some embodiments, the source device that supplies the audiovisual content can include a media drive configured to receive a non-transitory storage medium having audiovisual content stored thereon. However, this is not essential and, in some embodiments, such a source device can instead be a reader of data from another type of data source device, for example a solid-state memory device that supplies data. The data source device can be internal or external to the apparatus. Internal data source devices could include hard disk drives and source devices involving the reception of data from a network, such as the Internet or a private link over a public or private network.

According to another embodiment, the disclosure provides a method for providing audiovisual content for reproduction on a mobile device. The method includes controlling a conversion module to use a codec to convert audiovisual content according to target device configuration information, and to provide the converted audiovisual content at an output.

According to yet another embodiment, the disclosure provides another apparatus for providing audiovisual content for reproduction on a mobile device. The apparatus includes: an audiovisual content supply arrangement; the apparatus being arranged to write into an area of memory data constituting audiovisual content; two or more different media players; and a loader program, the loader program being arranged such that when loaded into a mobile device it causes configuration parameters of the mobile device to be determined, causes one of the media players to be selected on the basis of the detected configuration parameters, and controls the mobile device to use the selected media player.

According to still another embodiment, the disclosure provides data stored on a portable medium or existing at least transiently in memory. The data constitute audiovisual content; two or more different media players; and a loader program, the loader program being arranged such that when loaded into a mobile device it causes configuration parameters of the mobile device to be determined, causes one of the media players to be selected based at least on the detected configuration parameters, and controls the mobile device to use the selected media player.

According to a further embodiment, the disclosure provides a method for providing audiovisual content for reproduction on a mobile device. The method includes: writing into an area of memory data constituting audiovisual content; two or more different media players; and a loader program, the loader program being arranged to cause a mobile device to determine configuration parameters of the mobile device, to select one of the media players on the basis of the detected configuration parameters, and to control the mobile device to use the selected media player.

According to another embodiment, the disclosure provides a method for operating a mobile device. The method includes: storing audiovisual content data and two or more different media players in internal and/or external memory; determining configuration parameters of the mobile device, selecting one of the media players on the basis of the detected configuration parameters, and using the selected media player to consume the audiovisual content data.

The term “mobile device” will be understood to embrace mobile (cellular) telephones, personal digital assistants, and other portable devices having bidirectional (or, in some instances, unidirectional) voice and/or data communication capabilities, as well as other types of mobile devices, including dedicated media players, smartphones, smartwatches, tablet computers, and the like.

### DETAILED DESCRIPTION

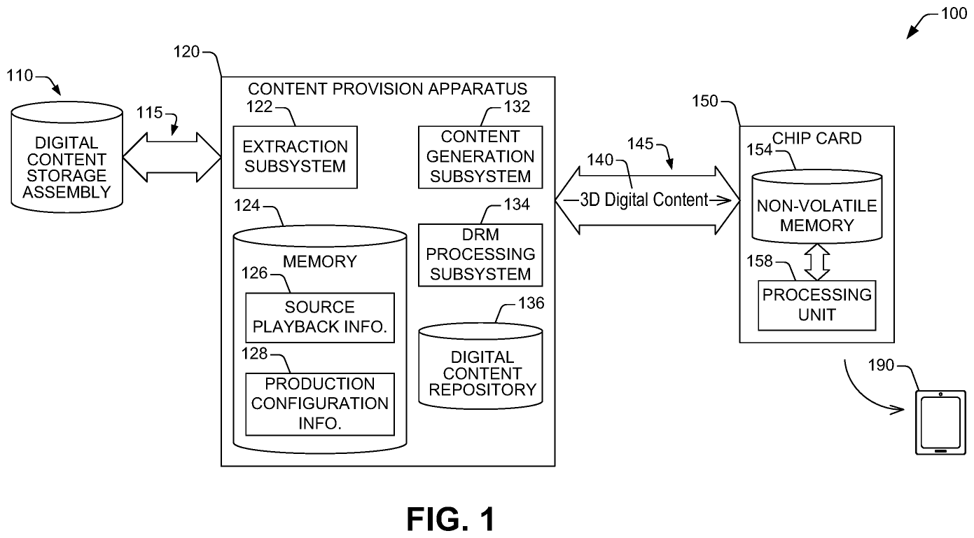

FIG. 1 illustrates an example of an operational environment 100 to provision 3D content to portable chip cards, in accordance with one or more embodiments of this disclosure. The illustrated operational environment 100 includes a digital content storage assembly 110 that serves as a source of digital content. The digital content includes, for example, motion pictures formatted according to one or several multimedia formats. The motion pictures can include, for example, video games (full motion or otherwise), 2D animations, 2D live-action pictures, 3D animations, 3D live-action pictures, or a combination thereof. The digital content storage assembly 110 can include, for example, multiple memory devices including at least one non-transitory storage medium. The digital content is retained in the at least one non-transitory storage medium. In some embodiments, the digital content storage assembly 110 includes an optical disc drive (ODD) that can receive a first non-transitory storage medium of the at least one non-transitory storage medium. The first non-transitory storage medium can be one of a DVD or a BD. In addition, or in other embodiments, the digital content storage assembly 110 includes at least one memory device having one or more non-transitory storage media. A first memory device of the at least one memory device can be one of a hard disk drive (HDD) or a solid-state drive (SDD).

The digital content storage assembly 110 is functionally coupled to a content provision apparatus 120 by means of a communication architecture 115. The communication architecture 115 permits the exchange of information between the digital content storage assembly 110 and the content provision apparatus 120. To that end, in some embodiments, the communication architecture 115 includes bus architectures, router devices, aggregator servers, a combination thereof, or the like.

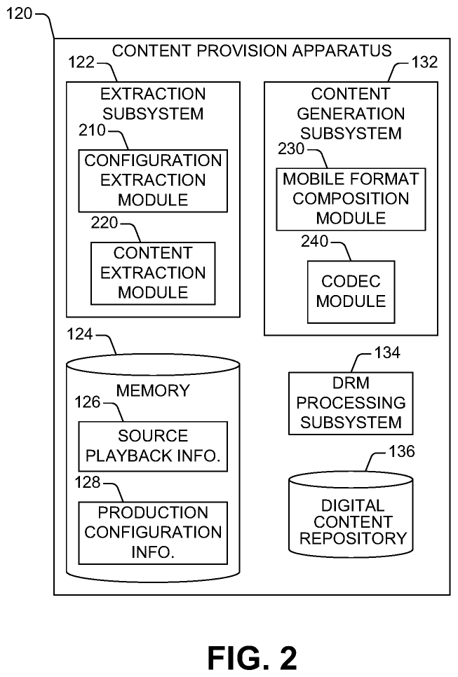

The content provision apparatus 120 can access digital content and associated playback information from the digital content digital storage assembly 110. To that end, the content provision apparatus 120 can include an extraction subsystem 122 that can extract information (e.g., content data and/or metadata) from the digital content storage assembly 110. As an illustration, the digital content storage assembly 110 can include a non-transitory storage medium, such as a DVD or a BD. The extraction subsystem 122 can read specific digital content from the non-transitory storage medium. The extraction subsystem 122 also can implement a probe component (e.g., transcode in Linux (which includes tcprobe) or other types of probe programs) that determines source playback information from the non-transitory storage medium. The source playback information can be indicative of reproduction elements of the specific digital content retained in the non-transitory storage medium. The source playback information can be retained in one or more memory devices 125 (generically referred to as memory 124) within one or more memory elements 126. In some embodiments, as is illustrated in FIG. 2, the extraction subsystem 122 includes a configuration extraction module 210 that can implement the probe component and retrieve or otherwise receive the source playback information.

The reproduction elements can include, for example, an aspect ratio; a number of video channels (main content, subtitles, etc.); a video resolution; a total number of frames; frame rate; video resolution; video bitrate; a number of audio tracks; a number and/or type of audio channels; audio sampling rate; audio bitrate; a total duration of the source digital content. The reproduction elements can convey, for example, a specific pixel resolution or a combination of several pixel resolutions for video reproduction, such as 320×240 (240p), 426×240, 480×360 (360p), 640×360, 640×480, 854×480 (480p), 888×480, 848×480, 720×480, 800×480, 1136×640, 1280×720 (720p), 1334×750, 1024×768, 1792×828, 2048×1536, 2208×1242, 2224×1668, 2436×1125, 2732×2048, 4K resolutions (e.g., 3840×2160 and 4096×2160) or 8K resolution (e.g., 7680×4320). In one example, the video resolution can be 720×480 (480p) pixel resolution and the video bitrate can be 9.8 Mbps. In another example, the video resolution can be 1920×1080 (1080p) pixel resolution and the video bitrate can be 9.8 Mbps.

Implementation of the probe component also can identify, for example, multiple files that represent the digital content retained in the non-transitory storage medium. Each one of the multiple files has a defined video format, such as Vob, MPEG-1, MPEG-2, MPEG-4, MPEG Transport Stream, H.264, H.265, and VC-1, or the like. Accordingly, video components and audio components of the digital content can be arranged according to a defined video coding format and a defined audio coding format, respectively. The defined video coding format and the defined audio coding format are consistent with, or otherwise correspond to, the defined video format.

The extraction subsystem 122 also can read or otherwise access digital content from the digital content storage assembly 110. The extraction subsystem 122 can read or otherwise access the digital content from at least one non-transitory storage medium included in the digital content storage assembly 110. In some instances, the extraction subsystem 122 can read encoded content data representative of the digital content. For example, the content data can be embodied in a series of files having a defined video format. In other instances, rather than accessing encoded content data representative of the digital content, the extraction subsystem 122 also can decode the content data based at least on the video coding format and/or audio coding format corresponding to the video format of the digital content. Thus, a source version (or production version) of the digital content can be available to the content provision apparatus 120 for various types of processing, including scene analysis, 2D-to-3D transformation, or the like. The source playback information extracted by the configuration extraction module 210 can identify the particular video coding format and/or audio coding format to decode the digital content.

In some instances, prior to decoding the digital content, the extraction subsystem 122 can decrypt the digital content. To that end, the extraction subsystem 122 can use at least one or multiple cryptographic content-keys read or otherwise received by the configuration extraction module 210, FIG. 2. The cryptographic content-key(s) can have a defined size greater than 40-bit (56-bit, 128-bit, 192-bit, 256-bit, etc.). In one example, the source playback information extracted by the configuration extraction module 210 can identify the cryptographic keys(s). In particular, yet not exclusively, the configuration extraction module 210 can have a cryptographic reproduction-key that can be retained in the memory 124. The cryptographic reproduction-key can permit decrypting a cryptographic source-key associated with specific content in the digital content storage assembly 110. The cryptographic source-key permits, in turns, accessing the cryptographic content-key(s). Continuing with the foregoing illustration directed to a DVD or BD, the extraction subsystem 122 can read the multiple files retained in the DVD or BD. The extraction subsystem 122 can then decrypt and decode the digital content read from the multiple files. As is illustrated in FIG. 2, in some embodiments, the extraction subsystem 122 includes a content extraction module 220 that can decode digital content from the digital content storage assembly 110. The content extraction module 220 also can decrypt the digital content.

The extraction subsystem 122 can retain the digital content that is accessed in one or more memory devices 136 (referred to as digital content repository 136). In some instances, the production version of the digital content can be retained in the digital content repository 136. In other instances, the digital content can be retained in an intermediate container format, such as audio video interleave (AVI), MOV, Academy Color Encoding System (ACES), or the like. The intermediate container format can permit converting the accessed digital content from a first video format in which the digital content is read to a second video format. Thus, the digital content accessed from the digital content storage assembly 110 can be formatted for reproduction at a specific type of mobile device that can utilize the second video format. For instance, the digital content accessed in either MPEG-2 format or VC-1 format can be converted to MPEG-4 format by using, at least, the intermediate container format.

In order to convert accessed digital content—e.g., encoded digital content received from the digital content storage assembly 110 or a production version of the digital content—to a particular video format, the content provision apparatus 120 can include a content generation subsystem 132. The content generation subsystem 132 can access production configuration information indicative of a configuration for digital content reproduction at a specific type of mobile device (e.g., a smartphone, a tablet computer, or a videogame console). The production configuration information can include the same or similar type of reproduction elements included in the source playback information retained in the memory element(s) 126. In addition, the production configuration information also can include other types of elements that convey hardware components for the reproduction of digital content at the mobile device. The production configuration information can be accessed from one or more memory elements 128 and can specify a hardware configuration, a software configuration, or both. In some embodiments, as is illustrated in FIG. 2, the content generation subsystem 132 includes a mobile format composition module 230 that can retrieve or otherwise receive the production configuration information.

More specifically, the production configuration information can convey, for example, a type of a display device (e.g., 2D display device or 3D display device) integrated in the mobile device; a pixel resolution of the display device; an aspect ratio for reproduction of digital content; a video resolution for reproduction at the mobile device; a video bitrate compatible with the mobile device; an audio bitrate compatible with the mobile device; a number of audio channels for audio reproduction; type of audio channels for audio reproduction; a video format for reproduction at the mobile device; a group of sensory devices present in the mobile device; a combination thereof; or the like. A sensory device is or includes a haptic device or another type of device that causes a physical effect at the mobile device. The production configuration information can convey a specific video resolution or a combination of several video resolutions for video reproduction. For instance, the production configuration information can convey one or more of the following video resolutions, 320×240 (240p), 426×240, 480×360 (360p), 640×360, 640×480, 854×480 (480p), 888×480, 848×480, 720×480, 800×480, 1136×640, 1280×720 (720p), 1334×750, 1024×768, 1792×828, 2048×1536, 2208×1242, 2224×1668, 2436×1125, 2732×2048, 4K resolutions (e.g., 3840×2160 and 4096×2160) or 8K resolution (e.g., 7680×4320). The production configuration information also can convey one or several aspect ratios for video reproduction, such as 16:9, 4:3, and 3:2.

The content generation subsystem 132 can utilize a combination of the accessed production configuration information and digital content retained in the digital content repository 136 to generate digital content for stereoscopic presentation at the mobile device. The digital content that is generated is therefore referred to as 3D digital content (or 3D content or 3D audiovisual content). The digital content that is generated is formatted according to a defined video format that can be utilized for reproduction at the mobile device. The content generation subsystem 132 can identify the defined video format by means of, in some embodiments, the mobile format composition module 230, FIG. 2, using an element of the production configuration information. More specifically, with further reference to FIG. 1, the content generation subsystem 132 can access digital content from the digital content repository 136 and can decode the accessed digital content. The digital content that is decoded by the content generation subsystem 132 can be formatted in an intermediate container format (e.g., AVI, MOV, ACES, or the like) and can correspond to a specific source playback configuration (e.g., specific video channel, two-channel audio track, and subtitle channel in a particular language). In some instances, the digital content that is accessed by the content generation subsystem 132 can be a production version of the content and, thus, decoding of the accessed digital content is not be necessary. The content generation subsystem 132 can encode the decoded digital content according to the defined video format and a group of elements of the configuration for digital content reproduction at the mobile device. For instance, the group of elements can specify an aspect ratio, a video resolution, and video bitrate and audio bitrate that are acceptable or intended for the digital content generated by the content generation subsystem 132.

In some embodiments, with further reference to FIG. 2, the content generation subsystem 132 can include a codec module 240 that can decode the digital content that is accessed from the digital content repository 136. To that end, the codec module 240 utilizes a decoder that is consistent with a video coding format and audio coding format of the accessed digital content. The codec module 240 can in turn encode the decoded digital content in the defined video format for reproduction at the mobile device and according to particular video bitrate and audio bitrate specified in the production configuration information. As an illustration, the accessed digital content can be formatted in AVI format and the codec module 240 can extract data indicative of the accessed digital content by decoding information in AVI format. To that end, the codec module 240 utilizes a decoder that is consistent with a video coding format and an audio coding format for the AVI container. The codec module 240 can encode the extracted data according to the defined video format (MPEG-1, MPEG-2, MPEG-4, MPEG Transport Stream, H.264, H.265, VC-1, or the like) at specified video and audio bitrates.

In some scenarios, the digital content that is decoded from the digital repository 136 is configured for stereoscopic presentation. In other words, the digital content includes 3D audiovisual content. Thus, the generation of digital content for consumption at a mobile device can entail the adjustment of the decoded digital content, without substantially changing the structure of the accessed digital content.

In other scenarios, the digital content that is decoded from the digital repository 136 is configured for 2D presentation—e.g., the digital content includes 2D audiovisual content. In those scenarios, the content generation subsystem 132 can modify the structure of the decoded digital content in order to arrange the decoded digital content for stereographic presentation prior to adapting such digital content for stereographic presentation in the mobile device as is described herein. In other words, the content generation subsystem 132 can produce 3D audiovisual content using the 2D audiovisual content. Then, the 3D audiovisual content that is produced can be adapted for stereographic presentation at the mobile device. To that end, in some embodiments, the mobile format composition module 230 shown in FIG. 2 can modify the decoded digital content. The mobile format composition module 230 can generate two or more new frames corresponding to respective vantage points (or camera viewpoints) for a scene in a source frame in the decoded digital content. The vantage points can be similar, differing slightly (e.g., a few degrees, a degree, or a fraction of a degree). The mobile format composition module 230 can perform such a modification for at least some of the source frames in the decoded digital content. The new frames so generated can be processed in accordance with aspects described herein in order to generate 3D audiovisual content for consumption at a mobile device.

With further reference to FIG, 1, in some embodiments, the content provision apparatus 120 also includes a DRM processing subsystem 134 that can add DRM information to the digital content that is generated for consumption at a specific type of mobile device. The DRM information can include DRM data, related DRM metadata, or both. The DRM information can be added based at least on the video format identified by the production configuration information retained in the memory element(s) 128. In some embodiments, the particular form of the DRM content can be based at least on a particular implementation of the codec module 240, FIG. 2. Such an implementation can in turn dictate, at least partially, another implementation of a codec module in a media player utilized by the mobile device.

In instances in which it is allowed by the media player and/or the mobile device, the DRM information can impose content reproduction and distribution restrictions as follows. In one embodiment, the consumption of digital content can be limited to the mobile device or a user account associated with the mobile device. The user account can be identified, for example, by an international mobile equipment identity (IMEI), an international mobile subscriber identity (IMSI) number, or any other unique or quasi-unique identifier (a number, a keyword, a keyphrase, a string of alphanumeric characters, etc.). In such an embodiment, the identifier is included in at least one of the memory element(s) 128 so that the mobile format composition module 230 (see FIG. 2) can operate with the DRM processing subsystem 134 and the production configuration information to include suitable DRM information in the digital content that is encoded.

In another embodiment, the digital content can be consumed for a defined period ending on a particular time and/or date. In yet another embodiment, the digital content can be viewed on a defined number of occasions, e.g., N times, with N a natural number. After the movie has been viewed N times, a media player in the mobile device prevents further consumption of the digital content. Alternatively, the media player may be arranged to delete the movie data from a chip card or to corrupt the movie data immediately after the Nth viewing. In addition, or in still other embodiments, the DRM information can prevent the digital content from being copied or forwarded if not authorized.

In some instances, the DRM information can be encrypted and included in the header of resulting movie data representative of the digital content produced by the content provision apparatus 120. The disclosure is not limited in that respect and the DRM information can be integrated into the digital content in any suitable way. In scenarios in which a standard DRM process is required to be implemented by the mobile device intended for consumption of the digital content, the mobile format composition module 230 (see FIG. 2) and the DRM processing subsystem 134 can integrate the DRM information into the digital content in conformance to the defined standard DRM process.

The content provision apparatus 120 can output or otherwise write 3D digital content 140 to a chip card 150. The 3D digital content 140 also can be referred to as 3D audiovisual content 140. The 3D digital content 140 is generated by the content generation subsystem 132 and can include DRM data, in accordance with aspects of this disclosure. The 3D digital content 140 can be written on one or multiple non-volatile memory devices 154 integrated into the chip card 150. A communication architecture 145 can permit outputting information indicative of the 3D digital content 140 to the chip card 150. To that end, in some embodiments, the communication architecture 145 includes bus architectures, router devices, aggregator servers, a combination thereof, or the like. The information includes content data indicative of the 3D digital content 140. The information also can include metadata that specifies playback elements for the 3D digital content 140. A processing unit 158 integrated into the chip card 150 can receive the information and can write the information to the non-volatile memory device(s) 154. The processing unit 158 can include one or multiple processors or other types of processing circuitry. The processing unit 158 can be embodied in a dedicated chipset, such as a application-specific integrated circuit (ASIC) or a field programmable gate array (FPGA).

The chip card 150 can be embodied in or can constitute, for example, a Subscriber Identification Module (SIM) card; a Secure Digital (SD) memory card having a processing unit (such a card referred to as a SD chip card); or an MMC memory card having a processing unit (such a card referred to as an MMC chip card). The particular type of the chip card 150 can be determined by the protocol utilized to store and access information in the non-volatile memory 154, the form factor of the chip card 150, or both. The chip card 150 memory card can be functionally connected to a mobile device 190 by means of a suitable connector and interface (not shown in FIG. 1). Depending on the type of the chip card 150, the suitable connector and interface in the mobile device 190 can be one of an MMC slot, a SD slot, or a SIM slot, for example. The connector and interface in the mobile device 190 can functionally connect to a corresponding interface in the chip card 150. Such an interface permits or otherwise facilitates the processing of the content data indicative or otherwise representative of digital content in the chip card 150 by the mobile device 190. While the mobile device 190 is generically depicted as a tablet computer, the disclosure is not limited to such a type of device. Elements of the functionality of the operational environment 100 and other environments can be implemented in other types of mobile devices, such as a laptop computer, a smartphone, a smartwatch, a portable videogame console, and the like.

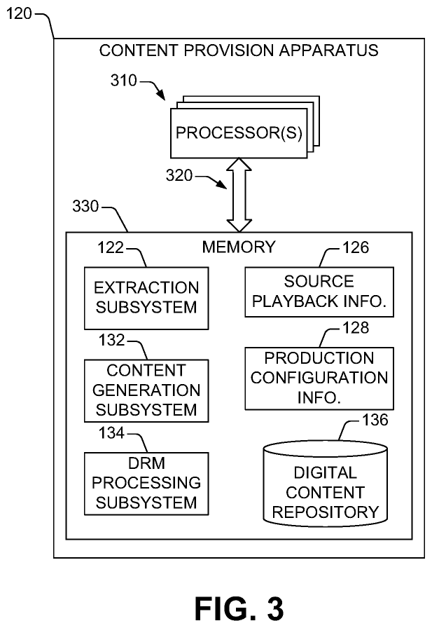

FIG. 3 is a block diagram of an example of a computing architecture that constitutes the content provision apparatus 120, in accordance with one or more embodiments described herein. The illustrated content provision apparatus 120 includes one or multiple processors 310 and one or multiple memory devices 330 (referred to as memory 330). In some embodiments, the processor(s) 310 can be arranged in a single computing apparatus, such as a blade server device or another type of server device. In other embodiments, the processor(s) 310 can be distributed across two or more computing apparatuses (e.g., multiple blade server devices or other types of server devices).

The processor(s) 310 can be functionally coupled to the memory 330 by means of a communication architecture 320. The communication architecture 320 can include one or multiple interfaces, for example. The interface(s) can be embodied in interface devices, software interfaces retained in memory devices, or a combination of both of those types of interfaces. The communication architecture 320 can be suitable for the particular arrangement (localized or distributed) of the processor(s) 310. In some embodiments, the communication architecture 320 also can include one or more bus architectures. The bus architecture(s) can be embodied in, or can include, one or more of several types of bus structures, including a memory bus or a memory controller, a peripheral bus, an accelerated graphics port, and a processor or local bus using any of a variety of bus architectures. As an illustration, such architectures can include an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, a Peripheral Component Interconnect (PCI) bus, a PCI-Express bus, a Personal Computer Memory Card International Association (PCMCIA) bus, a Universal Serial Bus (USB), a combination thereof, or the like. In addition, or in some embodiments, at least one of the bus architecture(s) can include as an Ethernet-based industrial bus, a controller area network (CAN) bus, a Modbus, other types of fieldbus architectures, or the like. In addition, or in other embodiments, the communication interface(s) can include a wireless network and/or a wireline network having respective footprints.

The memory 330 can retain or otherwise store therein machine-accessible components (e.g., computer-readable components and/or computer-executable components) in accordance with this disclosure. As such, in some embodiments, machine-accessible instructions (e.g., computer-readable instructions and/or computer-executable instructions) embody or otherwise constitute each one of the machine-accessible components within the memory 330. The machine-accessible instructions are encoded in the memory 330 and can be arranged to form such machine-accessible components. The machine-accessible instructions can be built (e.g., linked and compiled) to form software and can be retained in computer-executable form in the memory 330 (as is shown in FIG. 3) or in one or more other machine-accessible non-transitory storage media. Specifically, as is illustrated in FIG. 3, in some embodiments, the machine-accessible components include the extraction subsystem 122, the content generation subsystem 132, and the DRM processing subsystem 134. While the subsystems are illustrated as separate blocks, the disclosure is not limited in that respect. Indeed, the functionality provided in response to execution of the machine-accessible components also can be achieved with other arrangements of the illustrated subsystems.

The memory 330 also can retain information (e.g., data, metadata, or a combination of both) that, in combination with the machine-accessible components, can permit or otherwise facilitate the functions of the content provision apparatus 120, to generate 3D content for reproduction on at mobile device in accordance with aspects of this disclosure. As is illustrated in FIG. 3, such information can include source playback information retained in the memory element(s) 126; production configuration information retained in the memory element(s) 128; and digital content retained in the digital content repository 136.

The machine-accessible components, individually or in combination, can be accessed and executed by at least one of the processor(s) 310. In response to execution, the machine-accessible components, individually or in combination, can provide the functionality described herein. Accordingly, execution of the computer-accessible components retained in the memory 330 can cause at least one of the processor(s) 310—and, thus, the content provision apparatus 120—to operate in accordance with aspects described herein. More concretely, at least one of the processor(s) 310 can execute the machine-accessible components to perform or otherwise facilitate the functions of the content provision apparatus 120, to generate 3D content for reproduction on at mobile device in accordance with aspects of this disclosure.

While not illustrated in FIG. 3, the content provision apparatus 120 also can include other types of computing resources, such as other processors (graphics processing unit(s) or central processing unit(s), or a combination of both); other memory devices; disk space; downstream bandwidth and/or upstream bandwidth; interface device(s) (such as I/O interfaces and software interfaces retained in a memory device); controller devices(s); power supplies; and the like, that can permit or otherwise facilitate the execution of the machine-accessible components (e.g., subsystems, modules, and the like) retained in the memory 330. To that point, for instance, the memory 330 also can include programming interface(s) (such as application programming interfaces (APIs)); an operating system; software for configuration and or control of a virtualized environment; firmware; and the like.

In some embodiments, the digital content provision apparatus 120 also can generate 2D digital content for recordation in a chip card. The 2D digital content can be generated from other 2D digital content retained in the digital content storage assembly 110, in accordance with aspects of this disclosure.

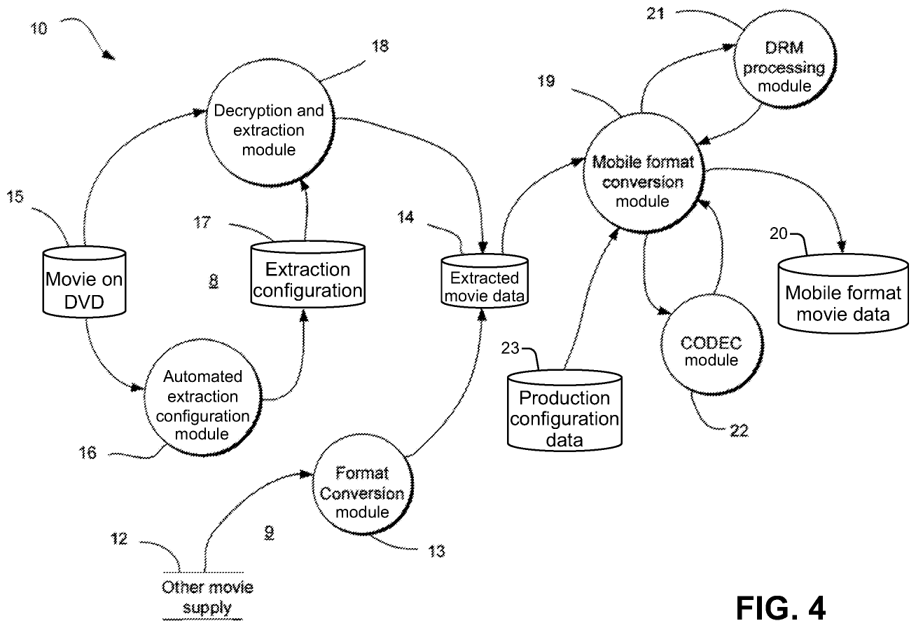

Referring to FIG. 4, content extracting and converting apparatus 10 is illustrated schematically, in accordance with one or more embodiments of this disclosure. Two alternative sources of audiovisual content 8, 9 are included. A first content source 8 utilizes film or movie data stored on a DVD (digital video disk or digital versatile disk) 15. An automated extraction configuration module 16 examines metadata stored on the DVD 15 to determine the configuration of content data stored on the DVD. This involves the application of a probe and an analysis of the information returned from the DVD 15. This is described in more detail below. The result is data stored in an extraction configuration memory area 17 representing an extraction configuration. The extraction configuration data from the memory area 17 can be utilized by a decryption and extraction module 18 to extract movie data (e.g., the content data) from the DVD 15. The result is content data in an intermediate format, which is written to an intermediate format movie data area 14. The data included in the intermediate format movie data area 14 is in predetermined format and is suitable for conversion into a form ready for reproduction on a mobile device (not shown in FIG. 4). In one example, the intermediate format is AVI. This format has the advantage of high resolution, yet is relatively easy to handle and it is relatively easy to convert from AVI into 3GPP, MPEG-4, H.264, H.265, and many other formats suitable for use by mobile devices.

The second source of audiovisual content 9 receives from a movie data storage area 12 data representing a movie (or film) in AVI, MOV, MPEG-2, MPEG-4, H.264, H.265, or other video formats. The movie so supplied is converted by a format conversion module 13 before being written to the intermediate format movie data area 14.

Thus, either of the audiovisual content sources 8, 9 can be used to provide movie data in the intermediate format movie data area 14.

A mobile format conversion module 19 converts movie data stored in the extracted movie data area 14 and provides a movie in mobile device consumable format. The movie can be retained in a mobile format movie data area 20. The mobile format conversion module 19 utilizes a DRM processing module 21, which allows certain control over the access and distribution of the resulting movie data. The conversion effected by the mobile format conversion module 19 uses a codec module 22, which can be custom-designed for the purpose. In one aspect, the conversion effected by the mobile format conversion module 19 can use information stored in a production configuration data area 23. By controlling the mobile format conversion module 19 based at least on information specific to the configuration of, and thus tailored to, a target mobile device, the apparatus 10 can be used to provide movie data for any of potentially a large number of target mobile devices.

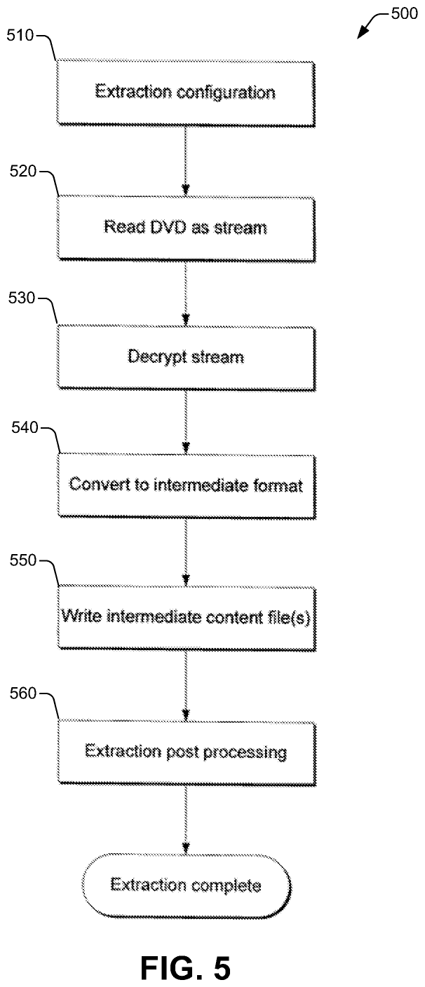

The extraction effected by the audiovisual content source 12 will now be described in detail with reference to the example technique 500 shown in FIG. 5.

In FIG. 5, extraction configuration is performed at block 510. This utilizes, in some embodiments, the automated extraction configuration 16 shown in FIG. 4. Extraction configuration commences by analyzing the DVD 15. The result of an example analysis, e.g., what is returned in response to a query, is illustrated below:

```
(dvd_reader.c) mpeg2 pal 16:9 only letterboxed UO 720x576 video
(dvd_reader.c) ac3 en drc 4SkHz 6Ch
(dvd_reader.c) ac3 de drc 48kHz 6Ch
(dvd_reader.c) ac3 en drc 48kHz 2Ch
(dvd_reader.c) subtitle OO=<en>
(dvd_reader.c) subtitle 01=<dc> o - 8
(dvd_reader.c) subtitle 02=<sy>
(dvd_reader.c) subtitle 03=<no>
(dvd_reader.c) subtitle 04=<da>
(dvd_reader.c) subtitle 05=<fi> s
(dvd_reader.c) subtitle 06=<is>
(dvd_reader.c) subtitle 07=<en>
(dvd_reader.c) subtitle 08=<de>
[tcprobe] summary for /media/dvdrecorder/, (*) = not default, 0 = not detected import frame size:
-g 720x576 [720x576]
      aspect ratio: 16:9(*)
      frame rate: -f 25.000 [25.000] frc=3
      audio track: -a O [O] -e 48000,16,2 [48000,16,2] -n Ox2000 [Ox2000]
      audio track: -a 1 [O] -e 48000,16,2 [48000,16,2] -n Ox2000 [Ox2000]
      audio track: -a 2 [O] -e 48000,16,2 [48000,16,2] -n Ox2000 [Ox2000]
[tcprobe] V: 185950 frames, 7438 sec (A 25.000 fps
[tcprobe] A: 116.22 MB (A 128 kbps
[tcprobe] CD: 650 MB I V: 533.8 MB (A 602.0 kbps
[tcprobe] CD: 700 MB I V: 583.8 MB (A 658.4 kbps
[tcprobe] CD: 1300 MB I V: 1183.8 MB (A 1335.1 kbps
[tcprobe] CD: 1400 MB 1 V: 1283.8 MB (A 1447.9 kbps
```

The foregoing information can be returned by tcprobe, which is part of transcode.

Part of the extraction configuration process of block 510 includes determining the configuration of the target mobile device, which is represented by the information stored in the production configuration data area 23. It is helpful therefore to understand the information that is stored there.

Information included in the production configuration data area 23 can identify the aspect ratio of the display of the target mobile device. In some cases, the aspect ratio is 4:3, although this may vary from device to device. Certain mobile devices can include 16:9 (e.g., widescreen) aspect ratio. The disclosure is not limited to particular aspects ratios. Indeed, in some embodiments, the aspect ratio may take a value which is not the same as a conventional television aspect ratio. The information stored in the production configuration data area 23 also identifies the audio language required. It also identifies whether or not subtitles are required. If they are required, the production information configuration identifies the language that the subtitles are required to be in. The bitrates of the video and the audio tracks are included in the production configuration data. The bitrates may depend on the capabilities of the target mobile device, on the particular media player installed in the target mobile device, or on any other factors.

The information included in the production configuration data are 23 may also indicate a maximum volume size, for example indicating the amount of usable memory in a memory card having a non-volatile memory device and processing circuitry. The memory card can be embodied in, or can include, an MMC chip card, an SD chip card, a SIM card, or the like. The production configuration information also includes an indication of the format on which the movie data is to be stored. For example, this format can be 3GPP, MPEG-4, H.264, H.265 format, or any other suitable format.

The information included in the production configuration data area 23 also can include the type of the target mobile device. This may be, for example, a model number of the mobile device on which the movie is to be reproduced. In some circumstances, it may be possible that two different mobile devices having the same model number can have different hardware and/or software configurations. Where different configurations are possible, and this may have a bearing on the satisfactory (optimum or nearly optimum) processing effected by the apparatus 10, the information stored in the production configuration data area 23 also includes details of how the hardware and/or software configuration departs from a standard configuration. In addition, or in other embodiments, such information can instead specify the hardware and/or software configuration.

The automated extraction configuration module 16 can determine from the information returned by tcprobe, (in particular the first line thereof reproduced above) that the DVD 15 contains only widescreen (that is 16:9 aspect ratio, for example) video in MPEG 2 PAL format. The automated extraction configuration module 16 also can determine that there are three audio tracks, identified by the second to fourth lines, respectively. The first and second tracks have 6 channels each and 48 kHz sampling rates. The first is in the English language and the second is in the Gcrman language, as identified by the “en” and “de” designations. The third audio track is in the English language and is a stereo (two channel) signal having a 48 kHz sampling rate. The automated extraction configuration module 16 also can determine that the DVD 15 has eight subtitle tracks, in various languages. The automated extraction configuration module 16 also can determine the frame rate, the number of frames, and the length of the movie. The automated extraction configuration module 16 can use the last four lines of the returned information to determine the content bitrate variations that can be extracted from the DVD 15.

The function of the automated extraction configuration module 16 also can include obtaining decryption keys, which are needed to allow the audiovisual content on the DVD to be reproduced. The information determined by the automated extraction configuration module 16 constitutes the configuration of the DVD 15.

Based on the information in the production configuration data area 23 and on the DVD configuration information, the automated extraction configuration module 16 can identify which audio tracks, which video channel (if there is more than one video channel) and which subtitle track are needed. In some instances, the subtitle track identified by this process is the first listed subtitle track which is in the same language as the subtitle language identified in the production configuration data area 23. Also, the audio track identified by this process is the audio track which is in the same language as the audio language identified in the production configuration data area 23 and which is most suitable for use by the target device. In some cases, Dolby™ Pro Logic™ audio channels may not be suitable because most target mobile devices may not be equipped to handle such audio signals. A stereo audio track can in most cases be the most suitable audio track, although any mono track may be most suitable for a target mobile device with only mono audio capabilities. The video channel selected by this process typically is the main channel, (e.g., the actual movie) and not any “additional features,” such as trailers and behind-the-scene documentaries, and the like that are commonly included on DVDs. Data identifying the tracks and channels identified by this process is stored in the extraction configuration data area 17.

At block 520, the data stored on the DVD 15 can be read as a stream. This is represented by the arrow between the movie on DVD 15 and the decryption and extraction module 18 in FIG. 4. Only the content may be read at this time, since the configuration information, or metadata, is not used by the decryption and extraction module 18 directly. Also, only the relevant content may be read. The relevant content can be identified to the decryption and extraction module 18 by the information stored in the extraction configuration data area 17. Such information identifies the relevant video channel, the relevant audio channel, and any relevant subtitle channel.

At block 530, the relevant portions of the DVD data stream can be decrypted by the decryption and extraction module 18. This decryption can use transcode with the keys extracted by the automated extraction configuration module 16. Decryption can be performed “on the fly.” e.g., as an essentially continuous process as the content is read from the DVD 15. As the data is decrypted, the data can be converted into an intermediate format at block 540, In one example, the intermediate format can be AVI format. At block 550, the movie data can be written into the extracted movie data buffer 14 as a single file or series of files in the intermediate format.

At block 560, extraction post-processing can be performed. This involves splitting or joining the content file or files present in the extracted movie data buffer 14 into components. Whether there is any splitting or any joining and the extent of it depends on the target device configuration information stored in the production configuration data area 23. In some instances, performing the extraction post-processing can include splitting the extracted content cleanly to multiple volumes. Providing movie content in the form of multiple volumes can be desirable in some instances due to the limitations of some mobile devices. It is a fairly straightforward procedure to split DVD movie content into volumes corresponding to the DVD chapters present on the original DVD 15. Following block 560, the extraction of the movie data is complete.

The result is movie data stored in the extracted movie data buffer 14 which is encoded into an intermediate format (e.g., AVI, MOV, ACES, or the like) and which includes only one audio track, which is in the required language identified by the production configuration information stored in production configuration data area 23, and optionally one subtitled channel, in the required language. The extracted movie data can be divided into a number of volumes, although this may not be necessary depending on the configuration of the target device.

In some embodiments, instead of using a DVD data source 15, the other movie data storage area 12 may be used. The movie data storage area 12 can be embodied in or can constitute a HDD; multiple HDDs; a SDD; multiple SDDs; a combination of the foregoing; or the like. In one example, the multiple HDDs can be part of a data center utilized to create source movie data. In such embodiments, format conversion to the intermediate format (for example AVI, MOV, ACES, or the like) can be carried out by the format conversion module 13. In scenarios in which only DVD sources can be used, then the second content source 9 can be omitted. In contrast, in scenarios in which the other movie data storage area 12 is included, the format conversion module 13 takes a form which is suitable for the particular type of content provided at the other movie data storage area 12. In some instances, a separate format conversion module 13 may be needed for each type of data that can be stored in the other movie data storage area 12.

Although some aspects of the disclosure are illustrated with reference to a DVD 15, the technologies disclosed herein are not limited in that respect. Indeed, the technologies disclosed herein can utilize digital content (such as movie data, animation data, etc.) from a Blu-ray disc (BD) source.

The example method 600 shown in FIG. 6 begins with the extraction process complete. At block 610, the extraction file can be read. This can be an “on the fly” procedure and is represented by the arrow linking the extracted movie data area 14 with the mobile format conversion module 19. At block 620, the mobile format conversion module 19 can decode the content including the movie data. To that end, in one example, the mobile format conversion module 19 can use the transcode suite of utilities in Linux or other types of multimedia analysis components.

.At block 630, the decoded content can be encoded into a required mobile format, as identified by the production configuration information stored in the production configuration data area 23. The encoding can be performed by the codec module 22. In some embodiments, the encoding can be performed in such a way as to result in audio content and video content having the most appropriate bitrates. The mobile format conversion module 19 can determine the most appropriate bitrates. In some embodiments, the mobile format conversion module 19 can use at least the number of video frames in the video data and the length of the audio track along with the maximum volume size information stored in the production configuration data area 23 to determine the most suitable bitrates. In some cases, the most suitable bitrates for the audio and video can be the bitrates which are the maximum possible bitrates which could be used to fit the entire content within the maximum volume size.

The bitrates selected for the audio and the video can give rise to comparable quality for those components. There can be some discrepancy, however, if this results in mobile format movie data which would give an improved reproduction (or playback) experience, to the extent that it is permissible by the maximum volume size. For example, if audio and video content at a certain quality level would give rise to data exceeding the maximum volume but that content at a quality level immediately below that would give rise to a significant shortfall of the volume size, the mobile format conversion module 19 may use the higher bitrate for the video content and the lower bitrate for the audio content, so as to make the best use of the available volume size.

In instances in which the information stored in the production configuration data area 23 reveals that the target mobile device is not optimized for video playback at the same frame rate as that of the DVD 15 (or another type of source device), the mobile format conversion module 19 may modify the frame rate of the content data so that it is optimized for the target mobile device. Such a modification can involve a reduction in the frame rate which may not be so noticeable as it would if a full size display were used. If an optimal frame rate is not equal to the source frame rate divided by an integer, then the mobile format conversion module 19 may use frame interleaving to effect a smooth result in the generated movie content when played back on a mobile device.

Block 630 thus utilizes information stored in the production configuration data area 23 to control the mobile format conversion module 19 to encode the data using the codec module 22 into the appropriate data format and with appropriate bitrates.

With further reference to FIG. 4, the production configuration data area 23 may be updatable according to the target mobile device which is of interest in a particular format conversion process. In this case, the production configuration data area 23 can store data for only one target device at a time, and this data can be changed as required. Alternatively, the production configuration data area 23 stores a set of data for each one of multiple target devices, and one of the data sets can be selected according to the particular target device of interest at a given time. In either case, the apparatus 10 can be controlled to carry out a format conversion process which is optimized for each one of multiple target device configurations.

At block 640, digital rights management content can be added to the encoded movie data by the mobile format conversion module 19, using the DRM processing module 21. The DRM content can be added based at least on the target format identified by the information stored in the production configuration data area 23. The particular form of DRM content that is added may depend at least on the form of the codec module 22. The form of the codec module 22 in turn has an effect on the form of the codec in the media player. In particular, yet not exclusively, when the codec module 22 is a custom codec, a custom form of DRM is used. Here, the form of DRM can be selected to provide satisfactory (e.g., optimal or nearly optimal) operation with the custom media player. If an off-the-shelf codec module, such as when Real Media™ is used as the codec module 22, a suitable DRM can be used.

In instances in which it is allowed by the media player and the target device, the DRM content may impose content reproduction and distribution restrictions as follows. In one embodiment, the viewing of the content is limited to the particular target device or user, as for example identified by an international mobile equipment identity (IMEI) or an international mobile subscriber identity (IMSI) number or any other unique or quasi-unique serial number. In this case, the serial number is to be included in the production configuration data area 23, so that the mobile format conversion module 19 can operate with the DRM processing module 21 and the production configuration data area 23 to include suitable DRM content in the encoded movie data.

In another embodiment, the movie content is viewable up until a particular time and/or date. Thus, the resulting movie can have a “shelf-life” and is not be viewable after the date and/or time specified by the DRM content. In yet another embodiment, the movie content is viewable on a predetermined number of occasions (N times). Upon viewing the movie N times, or after the movie has been viewed N times, the media player in the target device does not allow the content to be viewed again. Alternatively, the media player may be arranged to erase the MMC or otherwise delete or corrupt the movie data immediately after the Nth viewing.

In addition, or in still other embodiments, the DRM content can prevent the movie content from being copied or forwarded if not authorized. Thus, it can be said that the DRM content prevents or deters the copying of the movie content and/or the consumption of the movie content on mobile devices other than the one for which it was intended.

The DRM content can be encrypted and included in the header of resulting movie data. The disclosure is not limited in that respect and the DRM content may be included in the movie data in any suitable way. Clearly, if a standard DRM process is required to be used by the target device, the DRM content included in the movie data by the mobile format conversion module 19 in the DRM processing module 21 can conform to the relevant standard.

At block 650, the target content can be written to the mobile format movie data area 20 as a file. In one example, the file may be written to an area of memory in a computer server. In another example, the content file may be written directly onto an MMC card or other portable transferable media. Regardless of the type of storage device in which the file is retained, the file includes content in the appropriate format and also DRM content. The DRM content can be embedded into the movie content or can be included in a separate file.

After block 650, the conversion is complete and the resulting data can be stored in the mobile format movie data area 20. The resulting data constitute the movie originally on the DVD data area 15 but encoded in a format suitable for use by the target mobile device and having appropriate audio and video content bitrates. Furthermore, the movie includes suitable DRM content, multiple volumes if appropriate to the format of the target mobile device, a single audio sound track, and optionally a single subtitle track.

Where the video content on the DVD 15 has a different aspect ratio to the display device of the target mobile device, there can be modification of the video signal from the DVD such that it corresponds to the aspect ratio of the target device. This can be carried out by the decryption and extraction module 18. Yet, modification of the video signal from the DVD 15 such that it corresponds to the aspect ratio of the target device can be carried out by the mobile format conversion module 19. The modification may involve simple cropping from the left and right sides of images if narrower images are required, or cropping from the top and bottom of images if wider images are required. In addition, or in the alternative, the modification may include a limited amount of image stretching, either widthwise or heightwise. In this case, it may be desirable to have more picture linearity in the central region of the display than at the edges of the display. Thus, compression or stretching is performed, to a greater degree, at the edges of the images than it is a central portion. The decryption and extraction module 18 or the mobile format conversion module 19, as the case may be, can be pre-programmed to make a determination as to what cropping and/or stretching is required on the basis of at least a look-up table relating course aspect ratios to target device aspect ratios and the corresponding modification required, or in any other suitable way.

In the embodiments described above, the data written to the mobile format movie data area 20 relates only to content data. In some embodiments, the data written to the mobile format movie data area 20 also includes one or more media players. This can be technically beneficial for a number of reasons. For example, it reduces the number of factors that need to be taken into account by the mobile format conversion module 19. The target mobile device configuration information does not need to include information identifying the media player included in the target mobile device, since this is not needed when the media player is included with the movie content data. As another example, it allows movie content data to be consumed even if no suitable media player, or indeed no media player at all, is included in the mobile device.

The media player or multiple players may be embedded, or alternatively included alongside, the movie content data. Embedding the media player into the content data can permit easier control of the movie content, and can make it difficult for the movie content data to be separated by unauthorized persons. In some cases, a media player can consume less than 1 MB of memory.

In one embodiment, a single custom media player is included with the movie content data. After the data is written onto a chip card (e.g., an MMC card, a SD chip card, or a SIM card), the data relating to the media player is extracted by the mobile device from the chip card and the media player is executed to process the movie content data.

In another embodiment, a number of different media players are stored, along with the movie content data and a loader program. The mobile device can be controlled to execute the loader program initially. The loader program can detect the relevant configuration of the mobile device and can determine therefrom which one of the media players to use to consume the movie content data. In this fashion, it is possible to utilize a chip card or another type of memory card (e.g., an MMC card or a SD card) for a greater number of target device configurations, which clearly can be technically beneficial, especially when memory cards are intended for retail from a shop display or similar.

If the media player is not a custom player, the loader program can be arranged to control the mobile device to detect whether or not it already includes a suitable media player. If a suitable media player is detected, this is controlled to be used instead of installing a media player from the MMC onto the mobile device.

This provides a technical benefit because it can reduce the possibility of there being an installation error or reinstallation error, thereby improving the efficiency and reliability of the mobile device.

In some embodiments, instead of including multiple separable media players, multiple media players may be provided through a single configurable media player software application. In such embodiments, the loader program may determine what media player is required, and operate appropriate software modules forming part of the media player software. Software module or functions which are not appropriate for the mobile device configuration are not used. Thus, multiple media players can be made up from a single software application, which can reuse modules or functions for certain media player functionality. Where a single media player software application is used, the loader program may form part of the media player software application itself

The movie content data, as well as any media player(s), stored in the mobile format movie data area 20 can be communicated to the target mobile device in any suitable way. In some embodiments, an MMC chip card and/or other transferable media can be used to store and transport the movie content. In other embodiments, where mobile data transfer is fast and economically viable, the movie content can be transferred over-the-air. For example, WAP, 3G, LTE, LTE-A, 4G, 5G, or 6G data transfer can be utilized. In yet other embodiments, transfer may be effected by transfer from an Internet connected PC which has downloaded the movie content from a website, using a short range link such as a cable, or wirelessly using various radio technology protocols, such as IrDA, Bluetooth·8, or near-field communication (NFC); or using a transferable storage medium such as an MMC card.

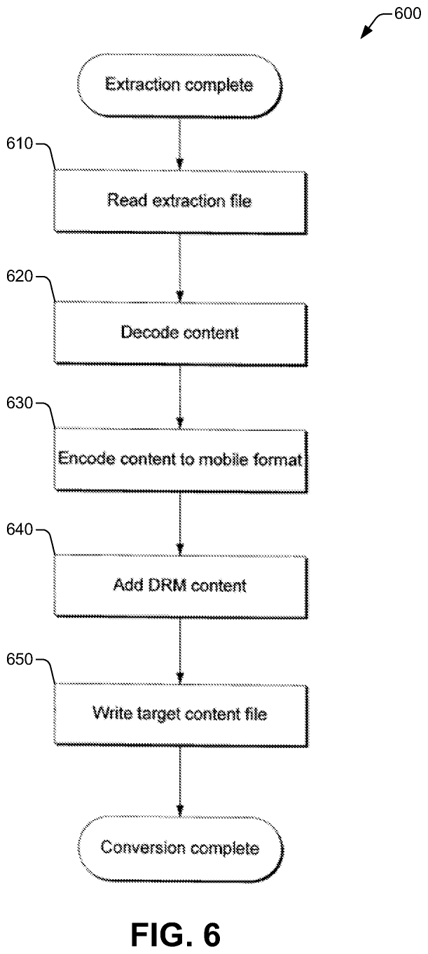

The technologies disclosed herein also can be applied to four-dimensional (4D) digital content. In some embodiments, as is illustrated in the operational environment 700 shown in FIG. 7, the content provision apparatus 120 can generate 4D digital content for recordation in the chip card 150. In some instances, the extraction subsystem 122 can access 4D digital content from the digital content storage assembly 110. The 4D digital content includes 3D digital content (e.g., digital content that is configured for stereoscopic presentation in a display device). The extraction subsystem 122 also can access source playback information indicative of reproduction elements of the 4D digital content. As is described herein, in order to generate other 4D digital content for reproduction at a specific type of mobile device (not shown in FIG. 7), the extraction subsystem 122 can further access production configuration information indicative of a configuration for digital content reproduction at such a mobile device. As in other embodiments of this disclosure, the production configuration information can be accessed from the memory element(s) 128. The production configuration information can specify a hardware configuration, a software configuration, or both.

In some embodiments, the extraction subsystem 122 can convert the 3D digital content included in the 4D digital content that is accessed from the digital content storage assembly 110 to an intermediate container format (e.g., AVI, MOV, ACES, or the like). The extraction subsystem 122 can retain the converted 3D digital content in the digital content repository 136.

The generation subsystem 132 can utilize a combination of the accessed production configuration information and the converted 3D digital content to generate 3D digital content for inclusion in the 4D digital content that can be consumed at the mobile device. Such 3D digital content can be formatted in a defined video format that can be utilized for reproduction at the mobile device. More specifically, the generation subsystem 132 can decode the converted 3D digital content from the digital repository 136. The converted 3D digital content that is decoded can correspond to a specific source playback configuration (e.g., specific video track, two-channel audio track, and subtitle channel in a particular language). The generation subsystem 132 can encode the decoded 3D digital content according to the defined video format and a group of elements of the production configuration information. The resulting encoded 3D digital content constitutes the 3D digital content for inclusion in the 4D digital content.

The extraction subsystem 122 can evaluate the 4D digital content and the source playback information for presence of metadata that permit controlling sensory effects. The sensory effects include haptic effects and other types of physical effects that can stimulate an end-user of the mobile device. In one example, the extraction subsystem 122 can initially evaluate the 4D digital content. In response to absence of such metadata, the extraction subsystem can then evaluate the source playback information. In another example, the 4D digital content and the source playback information can be implemented in reversed order. Regardless the manner in which the evaluation is performed, in one scenario, the extraction subsystem 122 can determine that such metadata are absent in both the 4D digital content and the source playback information. Thus, the extraction subsystem 122 can disregard 4D reproduction at the mobile device.

In another scenario, the extraction subsystem 122 can determine that metadata that permit controlling sensory effects (e.g., haptic effects) are present in either the 4D digital content or the source playback information. The metadata can be included, for example, within reproduction elements (e.g., a file that includes the metadata) of the source playback information. In addition, or as an alternative, the metadata can be embedded in the 4D digital content. In embodiments in which the digital content corresponds to a live-action motion picture, the metadata can include, for example, inertial data of a point-of-view camera (body camera or another type of camera) that produces the digital content. A sensory device integrated into a mobile device that can playback the 4D digital content can cause the mobile device to move based on the inertial data, for example. In addition, or in other embodiments, the metadata can include a group of instructions that direct one or multiple sensory devices integrated into the mobile device to implement particular sensory effects. Such sensory devices can include haptic devices, such as eccentric motors or other types of vibrating device. The sensory devices also can include heating devices; cooling devices; light-emitting diodes (LEDs) and/or other types of lighting devices (solid-state devices or otherwise); and the like. The extraction subsystem 122 can retain the metadata in one or more memory elements 710 within the memory 124.

Further, the extraction subsystem 122 can access sensory device configuration information from one or more memory elements 720. The accessed sensory device configuration information is indicative of a group of sensory devices that can be included in the mobile device intended to consume 4D digital content. The extraction subsystem 122 can determine if at least some of the sensory effects (e.g., haptic effects) identified or otherwise characterized by the metadata can be implemented in the mobile device. To that end, the extraction subsystem 122 can analyze the sensory device configuration information. The extraction subsystem 122 can determine, in one scenario, that at least a subset of the sensory effects can be implemented by the group of sensory devices.

In some embodiments, the content generation subsystem 132 can form 4D digital content 740 by combining the metadata and the 3D digital content that is generated based at least on the 3D digital content accessed from the digital content storage assembly 110. In other embodiments, the content generation subsystem 132 can logically associate the metadata with the generated 3D digital content. The 4D digital content 740 still is constituted by the generated 3D digital content and the metadata associated therewith.

The content provision apparatus 120 can output the 4D digital content 740 to at least one of the non-volatile memory device(s) 154 integrated into the chip card 150. The processing unit 158 can receive the metadata and can write the information to the non-volatile memory device(s) 154. The metadata combined or associated with the 4D digital content include the portion of the accessed metadata that permits controlling at least the subset of the sensory effects.

In another scenario, the extraction subsystem 122 can determine that the sensory effects are incompatible with the sensory devices identified by the sensory device configuration information. In other words, the extraction system can determine that the sensory devices cannot implement motion; changes in lighting (e.g., dimming the backlight in a display screen or powering on an LED); changes in temperature; or other physical changes that correspond to the sensory effects. In response, a sensory metadata generation subsystem 730 can generate customized metadata indicative of haptic effects compatible with the group of haptic devices. To that end, the sensory metadata generation subsystem 730 can analyze the 3D digital content (or, in some embodiments, 2D digital content) accessed from the digital content storage assembly 110.

More specifically, the sensory metadata generation subsystem 730 can analyze scenes from the 3D digital content (or, as applicable, 2D digital content) in order to detect specific features for which a haptic effect or another type of sensory effect can be implemented. To analyze a scene the sensory metadata generation subsystem 730 can apply a machine-learning model to the scene. The machine-learning model can be encoded or otherwise retained in the sensory metadata generation subsystem 730. The machine-learning model is trained to identify specific features in the scene, each one of the specific features having a corresponding sensory effect. For instance, the machine-learning model can be trained to identify a group of features including an explosion, a vehicular chase, a change in velocity (a change in magnitude and/or direction), an accident, a shooting, use of a tool, use of a weapon, a combination thereof, or the like. The group of features can include visual features or aural features, or a combination of both. In order to train the machine-learning model, parameters that define the machine-learning model can be determined by solving a defined optimization problem, using training data in a supervised or unsupervised fashion. The training data includes defined scenes having one or more of the features to be identified in the digital content. The machine-learning model can be embodied in or can include, for example, a support vector machine (SVM), a regression model (such as a k-nearest neighbor (KNN) model); a neural network (NN), a convolutional neural network (CNN); a region-based CNN (R-CNN); a generative adversarial network (GAN); or the like.

Based at least on the analysis, the sensory metadata generation subsystem 730 can determine a group of sensory effects (haptic effects or otherwise) compatible with at least one sensory device of the group of sensory devices identified by the sensory device configuration information. The sensory metadata generation subsystem 730 can then generate data indicative of the group of sensory effects. As an illustration, first data of the data that is generated can be indicative of a first vibration having a first frequency and a first amplitude (e.g., a strong, low-frequency vibration). The first vibration can correspond to audiovisual content representative of an explosion within the digital content. Second data of the data that is generated can be indicative of a second vibration having a second frequency and a second amplitude (e.g., a weak, high-frequency vibration). The second vibration can correspond to audiovisual content representative of the shattering of glass within the digital content. Third data of the data that is generated can be indicative of a series of strokes corresponding to audiovisual content representative of shots fired within the digital content. In addition, the sensory metadata generation subsystem 730 can configure such data according to a format to control the group of sensory effects during reproduction of the 3D digital content. The configured data constitutes the customized metadata. The format can correspond to instructions according to a control protocol for the operation of actuators, switches, motors, and the like. The control protocol can be specific to a type of controller device included in the mobile device that reproduces the 3D content.

In some embodiments, the content generation subsystem 132 can form 4D digital content 740 by combining the customized metadata and the 3D digital content that is generated based at least on the 4D digital content accessed from the digital content storage assembly 110. In other embodiments, the content generation subsystem 132 can logically associate the customized metadata with the generated 3D digital content. The 4D digital content 740 still is constituted by the generated 3D digital content and the customized metadata associated therewith.

The extraction subsystem 122 can output the 4D digital content 740 to at least one of the non-volatile memory device(s) 154 integrated into the chip card 150. The customized metadata can be output as the metadata 140. Again, the processing unit 158 can receive the customized metadata and can write the information to the non-volatile memory device(s) 154.

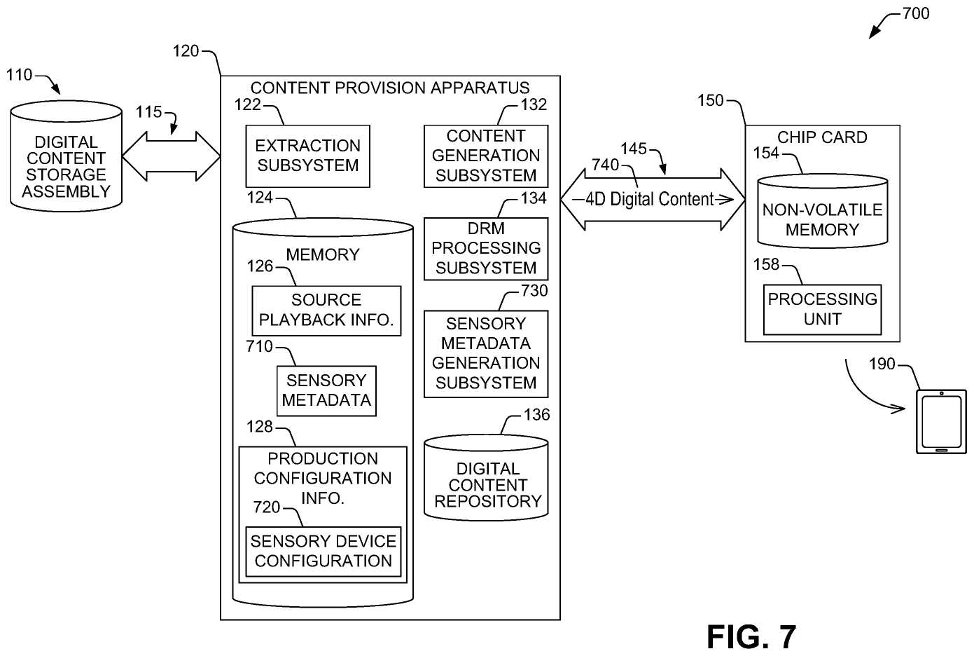

FIG. 8 is a block diagram of an example of another computing architecture that constitutes the content provision apparatus 120, in accordance with one or more embodiments described herein. The content provision apparatus 120 shown in FIG. 8 includes one or multiple processors 810 and one or multiple memory devices 830 (referred to as memory 330). In some embodiments, the processor(s) 810 can be arranged in a single computing apparatus, such as a blade server device or another type of server device. In other embodiments, the processor(s) 810 can be distributed across two or more computing apparatuses (e.g., multiple blade server devices or other types of server devices).

The processor(s) 810 can be functionally coupled to the memory 830 by means of a communication architecture 820. The communication architecture 820 can include one or multiple interfaces, for example. The interface(s) can be embodied in interface devices, software interfaces retained in memory devices, or a combination of both of those types of interfaces. The communication architecture 820 can be suitable for the particular arrangement (localized or distributed) of the processor(s) 810. In some embodiments, the communication architecture 820 can include one or more bus architectures. The bus architecture(s) can be embodied in, or can include, one or more of several types of bus structures, including a memory bus or a memory controller, a peripheral bus, an accelerated graphics port, and a processor or local bus using any of a variety of bus architectures. As an illustration, such architectures can include an ISA bus, an MCA bus, an EISA bus, a VESA local bus, an AGP bus, a PCI bus, a PCI-Express bus, a PCMCIA bus, a USB, a combination thereof, or the like. In addition, or in some embodiments, at least one of the bus architecture(s) can include an Ethernet-based industrial bus, a CAN bus, a Modbus, other types of fieldbus architectures, or the like. In addition, or in other embodiments, the communication interface(s) can include a wireless network and/or a wireline network having respective footprints.

The memory 830 can retain or otherwise store therein machine-accessible components (e.g., computer-readable components and/or computer-executable components) in accordance with this disclosure. As such, in some embodiments, machine-accessible instructions (e.g., computer-readable instructions and/or computer-executable instructions) embody or otherwise constitute each one of the machine-accessible components within the memory 830. The machine-accessible instructions are encoded in the memory 830 and can be arranged to form such machine-accessible components. The machine-accessible instructions can be built (e.g., linked and compiled) and retained in computer-executable form in the memory 830 (as is shown in FIG. 8) or in one or more other machine-accessible non-transitory storage media. Specifically, as is illustrated in FIG. 3, in some embodiments, the machine-accessible components include the extraction subsystem 122, the content generation subsystem 132, the DRM processing subsystem 134, and the sensory metadata generation subsystem 730. While the subsystems are illustrated as separate blocks, the disclosure is not limited in that respect. Indeed, the functionality provided in response to execution of the machine-accessible components also can be achieved with other arrangements of the illustrated subsystems.

The memory 830 also can retain information (e.g., data, metadata, or a combination of both) that, in combination with the machine-accessible components, can permit or otherwise facilitate the functions of the content provision apparatus 120 shown in FIG. 8, to generate 4D content for reproduction on at mobile device in accordance with aspects of this disclosure. As is illustrated in FIG. 8, such information can include source playback information retained in the memory element(s) 126; production configuration information retained in the memory element(s) 128, including sensory device configuration; sensory metadata retained in memory element(s) 710; and digital content retained in the digital content repository 136.

The machine-accessible components, individually or in combination, can be accessed and executed by at least one of the processor(s) 810. In response to execution, the machine-accessible components, individually or in combination, can provide the functionality described herein. Accordingly, execution of the computer-accessible components retained in the memory 330 can cause at least one of the processor(s) 810—and, thus, the content provision apparatus 120—to operate in accordance with aspects described herein. More concretely, at least one of the processor(s) 810 can execute the machine-accessible components to perform or otherwise facilitate the functions of the content provision apparatus 120, to generate 4D content for reproduction on at mobile device in accordance with aspects of this disclosure.

While not illustrated in FIG. 8, the content provision apparatus 120 also can include other types of computing resources, such as other processors (graphics processing unit(s) or central processing unit(s), or a combination of both); other memory devices; disk space; downstream bandwidth and/or upstream bandwidth; interface device(s) (such as I/O interfaces and software interfaces retained in a memory device); controller devices(s); power supplies; and the like, that can permit or otherwise facilitate the execution of the machine-accessible components (e.g., subsystems, modules, and the like) retained in the memory 830. To that point, for instance, the memory 830 also can include programming interface(s) (such as application programming interfaces (APIs)); an operating system; software for configuration and or control of a virtualized environment; firmware; and the like.

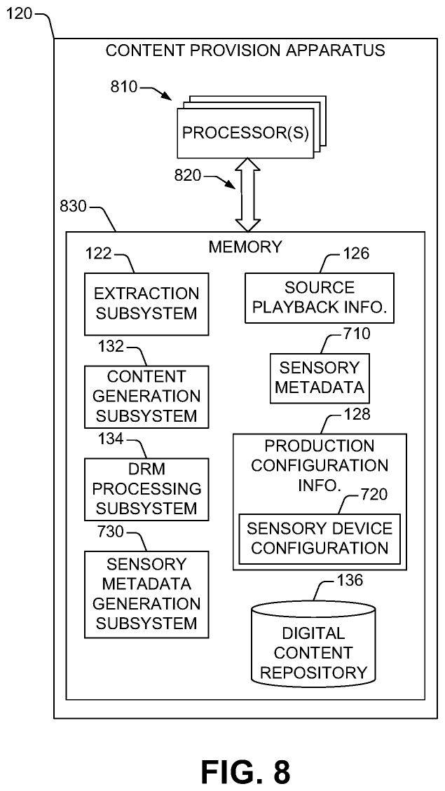

FIG. 9 illustrates an example of a method 900 for configuring a portable chip card with 3D digital content, in accordance with one or more embodiments of this disclosure. The example method 900 can be implemented, entirely or partially, by a computing system having or being functionally coupled to one or more processors; having or being functionally coupled to one or more memory devices; having or being coupled to other types of computing resources; a combination thereof; or the like. The computing resources can include operating systems (O/Ss); software for configuration and or control of a virtualized environment; firmware; central processing unit(s); graphics processing unit(s); virtual memory; disk space, downstream bandwidth, and/or upstream bandwidth, interface(s) (I/O interface devices, programming interface(s) (such as application programming interfaces (APIs), etc.); controller devices(s); power supplies; a combination of the foregoing; or the like. In some embodiments, the computing system can be embodied in, or can include, the content provision apparatus 120 in accordance with the various embodiments disclosed herein. In other embodiments, the computing system can be functionally coupled to such a content provision apparatus 120.

At block 910, the computing system can receive reproduction information indicative of reproduction elements of digital content retained in a storage assembly (e.g., digital content storage assembly 110). The storage assembly can include at least one non-transitory storage medium. In some embodiments, the reproduction information can be received in response to the computing system executing a probe component that analyzes the digital content. The probe component can be included in the extraction subsystem 122, which subsystem can be included I the computing system or functionally coupled thereto. In other embodiments, the reproduction information can be received in response to the digital content being created. For instance, the digital content can be created from a studio version (such as the theatrical version) of the digital content.

The reproduction information can constitute the source playback information described herein. The reproduction elements can include, for example, one or a combination of an aspect ratio of the digital content; a number of video channels (main content, subtitles, etc.) in the digital content; a number of frames in the digital content; video resolution; a frame rate; a video bitrate of the digital content; a number of audio tracks in the digital content; a number and/or type of audio channels in the digital content; audio sampling rate; audio bitrate; a total duration spanned by the total number of frames in the digital content.

At block 920, the computing system can receive the digital content from the storage assembly. The digital content can include, for example, 2D content, 3D content, or 4D content. As mentioned, the digital content can include, for example, video games, 2D animations, 2D live-action pictures, 3D animations, 3D live-action pictures, interactive motion pictures, 4D motion pictures, or a combination thereof. Receiving the digital content can include reading or otherwise accessing the digital content from at least one non-transitory storage medium included in the storage assembly. The digital content that is received can be formatted according to a defined video format, such as MPEG-2, H.264, VC-1, or the like. In some embodiments, the digital content also can be encrypted when retained in the storage assembly. Thus, receiving the digital content can include decrypting content data indicative of the digital content. The decryption can be implemented in accordance with aspects disclosed herein. Further, or in other embodiments, receiving the digital content can include formatting the digital content according to an intermediate container format (e.g., AVI, 3GP, MOV, ACES, or the like). The computing system can execute (or, in some instances, can continue executing) the extraction subsystem 122 or another type of software component having similar functionality in order to receive the digital content.

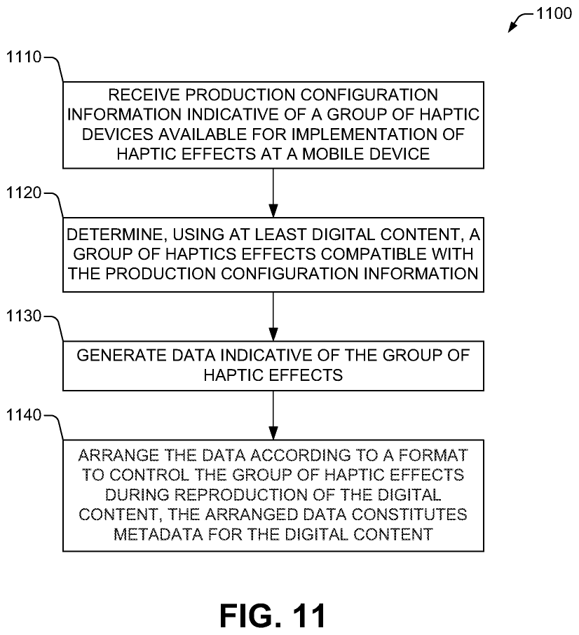

At block 930, the computing system can receive production configuration information indicative of a configuration for digital content reproduction at a mobile device (e.g., mobile device 190, FIG. 12). The production configuration information can be received from one or more memory devices (e.g., memory 124, FIG. 1) integrated into or otherwise functionally coupled to the computing system. In some embodiments, the production configuration information can be received in response to execution of the extraction subsystem 122 or another software component. As mentioned, the production configuration information can specify a hardware configuration, a software configuration, or both. Specifically, the production configuration information can convey, among other things, a type of a display device (e.g., 2D display device or 3D display device) integrated in the mobile device; a pixel resolution of the display device; an aspect ratio for reproduction of digital content; a bitrate for video reproduction; a bitrate for audio reproduction; number of audio channels for audio reproduction; type of audio channels for audio reproduction; a video format for reproduction at the mobile device; a group of sensory devices present in the mobile device; a combination thereof; or the like. In one example, the production configuration information can specify a 2D display device, a 1080p pixel resolution, a 4:3 or 16:9 aspect ratio, a frame rate of 60 frames per second (fps) or 30 fps, and two channels for audio reproduction (e.g., stereo reproduction). In another example, the production configuration information can specify a 2D display device, a 720p pixel resolution, a frame rate of 30 frames per second (fps), and two channels for audio reproduction (e.g., stereo reproduction). In yet another example, the production configuration information can specify a 2D display device, 720p pixel resolution, a 4:3 or 16:9 aspect ratio, a frame rate of 960 fps, and two channels for audio reproduction (e.g., stereo reproduction). In still another example, the production configuration information can specify a 2D display device, 1080p pixel resolution, a 4:3 or 16:9 aspect ratio, a frame rate of 120 fps or 240 fps, and two channels for audio reproduction (e.g., stereo reproduction). In a further example, the production configuration information can specify a 2D display device; 4K resolution; a 4:3 or 16:9 aspect ratio; a frame rate of 24 fps, 30 fps, or 60 fps; and two channels for audio reproduction (e.g., stereo reproduction).

At block 940, the computing system can generate second digital content for stereoscopic presentation at the mobile device. The digital content can be formatted according to a second video format that can be consumed at the mobile device. The second digital content can be generated based at least on a combination of the received digital content and one or more of the reproduction information or the production configuration information. To that end, in some embodiments, the computing system can execute (or, in some instances, can continue executing) the content generation subsystem 132 or another type of software component having similar functionality. In some embodiments, generating the second digital content can include converting the received digital content from a defined video format to an intermediate container format (AVI, 3GP, MOV, ACES, or the like). In addition, generating the second digital content can include decoding the converted digital content and formatting the decoded content according to the second video format. The production configuration information can specify, in some instances, the second video format. The production configuration information also can specify a defined aspect ratio and defined video bitrate and an audio bitrate to be utilized in the mobile device for reproduction of a stereographic representation of the digital content, for example. Thus, in one aspect, formatting the decoded digital content according to the second video format also can include formatting the decoded digital content according to the defined aspect ratio.

At block 950, the computing system can output the second digital content to a non-volatile memory device integrated into a chip card (e.g., chip card 150, FIG. 1). Outputting the second digital content includes writing the second digital content to the non-volatile memory device. To that end, in some embodiments, the computing system can execute (or can continue executing) the content generation subsystem 132 or another type of software component having similar functionality.

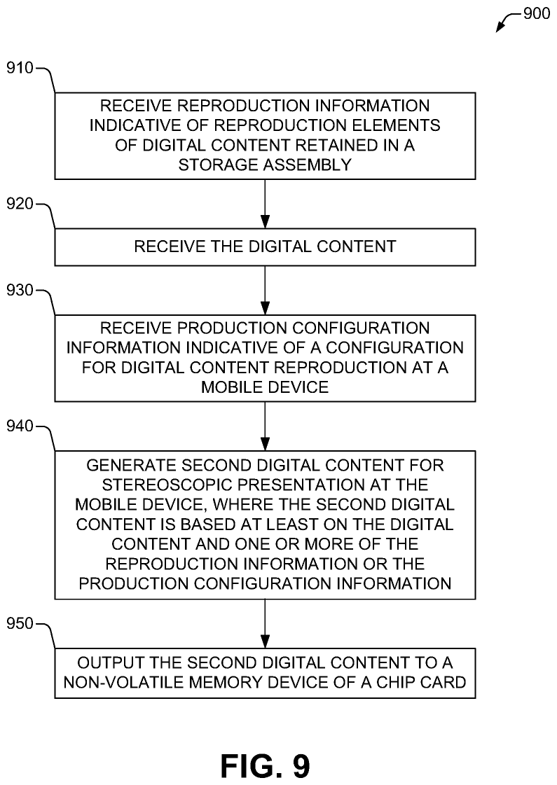

FIG. 10 illustrates an example of a method 1000 for configuring information representative of haptic effects associated with digital content in accordance with one or more embodiments of this disclosure. In some embodiments, at least a portion of the example method 1000 can be implemented in combination with the example method 900 to configure a portable chip card (e.g., chip card 150, FIG. 1) with 4D digital content in accordance with aspects of this disclosure.

A computing system having computing resources can implement, entirely or partially, the example method 1000. The example method 1000 can be implemented, entirely or partially, by a computing system having or being functionally coupled to one or more processors; having or being functionally coupled to one or more memory devices; having or being coupled to other types of computing resources; a combination thereof; or the like. The computing resources can include operating systems (O/Ss); software for configuration and or control of a virtualized environment; firmware; central processing unit(s); graphics processing unit(s); virtual memory; disk space, downstream bandwidth, and/or upstream bandwidth, interface(s) (I/O interface devices, programming interface(s) (such as application programming interfaces (APIs), etc.); controller devices(s); power supplies; a combination of the foregoing; or the like. In some embodiments, the computing system can be embodied in, or can include, the content provision apparatus 120 in accordance with the various embodiments disclosed herein. In other embodiments, the computing system can be functionally coupled to such a content provision apparatus 120.

At block 1010, the computing system can receive reproduction information indicative of reproduction elements of digital content. Block 1010 is essentially the same as block 910 and can be implemented in similar fashion. At block 1020, the computing system can receive production configuration information indicative of a configuration for digital content reproduction at a mobile device (e.g., mobile device 190, FIG. 12). Block 1020 is essentially the same as block 930 and can be implemented in similar fashion.

At block 1030, the computing system can determine if metadata that permits controlling haptic effects are present in reproduction elements included in the reproduction information. In one example, the metadata can be included in a file within the reproduction information. To that end, in some embodiments, the computing system can execute (or, in some instances, can continue executing) the extraction subsystem 122 or another type of software component. In response to a negative determination, at block 1040, the computing system can disregard augmented reproduction (e.g., 4D reproduction) of content at the mobile device. In some embodiments, instead of disregarding augmented reproduction at block 1040, the computing system can generate suitable metadata for augmented reproduction at the mobile device.

In the alternative, flow of the example method 1000 continues to block 1050 in response to a positive determination. At block 1050, the computing system can determine if the haptic effects associated with such metadata are compatible with a group of haptic devices identified in the production configuration information. A haptic device that can implement a control instruction to cause a defined haptic effect is said to be compatible with the defined haptic effect. In some embodiments, the computing system can perform such a determination by executing the extraction subsystem 122 or another type of software component. In response to a positive determination, the computing system can output the metadata to a non-volatile memory device integrated into a chip card (e.g., chip card 150, FIG. 1). Outputting the metadata includes writing the metadata to the non-volatile memory device. In response to a negative determination at block 1050, the example method 1000 continues to block 1060.

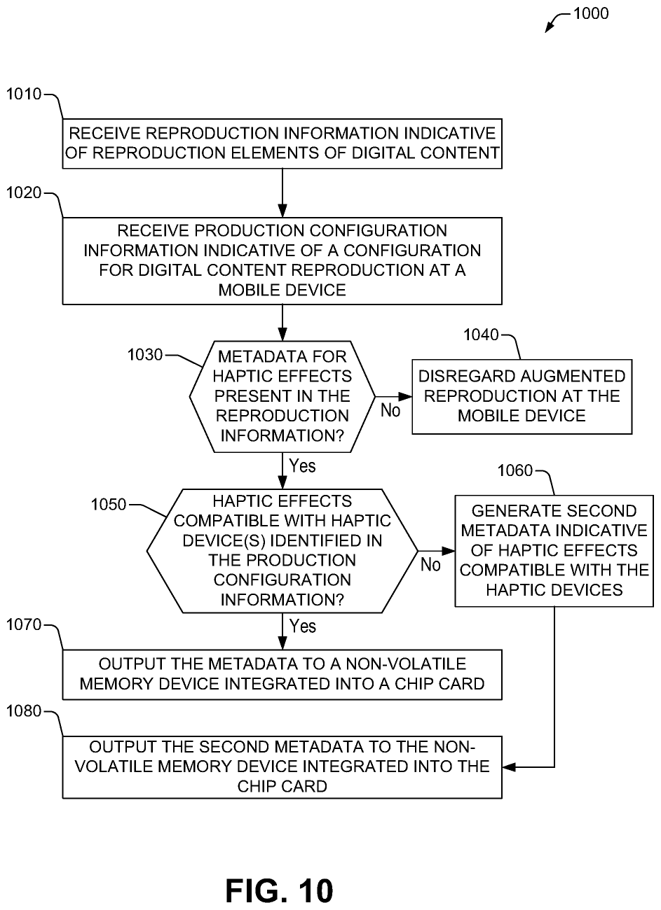

At block 1060, the computing system can generate second metadata indicative of haptic effects compatible with the group of haptic devices. To that end, the computing system can execute (or, in some instances, can continue executing) the sensory metadata generation subsystem 730 or another software component having similar functionality. The second metadata can be generated in accordance with the elements described in connection with FIG. 11.

At block 1080, the computing system can output the second metadata to the non-volatile memory device integrated into the chip card (e.g., chip card 150, FIG. 1). Outputting the second metadata includes writing the second metadata to the non-volatile memory device.

While the example method 1000 is disclosed in connection with haptic effects and haptic devices as elements that permit composing 4D content, the example method 1000 is limited in that respect. Indeed, the example method 1000 can be applied to the generation of 4D content based on sensory effects (including haptic effects) and 3D content. Numerous types of devices can be integrated into a mobile device or can be functionally coupled thereto to provide the sensory effects. In some embodiments, blocks 1030-1080 can be implemented in combination with the example method 900 to configure a portable chip card with 4D digital content in accordance with aspects of this disclosure.

FIG. 11 illustrates an example of a method 1100 for generating metadata to control haptic effects corresponding to 3D digital content, in accordance with one or more embodiments of this disclosure. The example method 1100 can be implemented, entirely or partially, by a computing system having or being functionally coupled to one or more processors; having or being functionally coupled to one or more memory devices; having or being coupled to other types of computing resources; a combination thereof; or the like. The computing resources can include operating systems (O/Ss); software for configuration and or control of a virtualized environment; firmware; central processing unit(s); graphics processing unit(s); virtual memory; disk space, downstream bandwidth, and/or upstream bandwidth, interface(s) (I/O interface devices, programming interface(s) (such as application programming interfaces (APIs), etc.); controller devices(s); power supplies; a combination of the foregoing; or the like. In some embodiments, the computing system can be embodied in, or can include, the content provision apparatus 120 in accordance with the various embodiments disclosed herein.

At block 1110, the computing system can receive production configuration information indicative of a group of haptic devices available for implementation of haptic effects at a mobile device. For example, the production configuration information can include a list of the haptic devices present in the mobile device.

At block 1120, the computing system can determine, using at least digital content, a group of haptic effects compatible with the production configuration information. Determining such a group of haptic effects can include determining features in the digital content for which features the haptic devices identified in the production configuration information can implement a defined haptic effect, e.g., a vibration, a stroke, a rotation, or the like. The features can be visual features or aural features, or a combination of both. Determining such features can include applying a machine-learning model to the digital content. As is disclosed herein, the machine-model can be trained to identify the features (an explosion, a vehicular chase, a collision, a shooting, etc.). The computing system can execute (or, in some instances, can continue executing) the sensory metadata generation subsystem 730 or another software subsystem with similar functionality in order to determine the group of haptic effects. Either of such subsystems can have encoded therein the machine-learning model, for example.

At block 1130, the computing system can generate data indicative of the group of haptic effects. To that end, the computing system can execute (or, in some instances, can continue executing) the sensory metadata generation subsystem 730 or another software subsystem with similar functionality. As an illustration, the group of haptic effects can include different types of vibrations (strong vibrations, sustained low-amplitude vibrations, etc.) based on respective events in a scene or group of scenes.

At block 1140, the computing system can configure the data according to a format to control the group of haptic effects during reproduction of the digital content. The format can correspond to instruction definitions according to a control protocol for the operation of actuators, switches, motors, and the like. The control protocol can be specific to a type of controller device included in a mobile device (e.g., mobile device 190) that can implement such effects. Thus, in some embodiments, configuring the data in such a manner can include generating, using at least the data, one or several control instructions to implement the group of haptic effects in the mobile device. As an example, explosions, vehicle collisions, and the like can result in metadata that directs a device to produce a strong vibration. As another example, shots in a scene can result in metadata that can direct a device to produce short, strong strokes. The configured data constitutes metadata for the digital content. The computing system can execute (or, in some instances, can continue executing) the sensory metadata generation subsystem 730 or another software subsystem with similar functionality in order to configure the data in such a fashion.

While the example method 1100 is disclosed in connection with haptic effects and haptic devices as elements that permit composing 4D content, the example method 1000 is limited in that respect. Indeed, the example method 1100 can be applied to the generation of 4D content based on sensory effects (including haptic effects) and 3D content. Numerous types of devices can be integrated into a mobile device or can be functionally coupled thereto to provide the sensory effects.

An example of a mobile device 190 in accordance with aspects of this disclosure is schematically illustrated FIG. 12. Here, the mobile device 190 includes all the components needed for voice and data communication, although such components are not shown for the sake of clarity. The mobile device 190 includes a movie decoder module 41, which is in bidirectional communication with a codec module 42. A movie is stored in a mobile movie data area 43 included in one or more memory devices (not shown in FIG. 4). The mobile movie data area 43 can be embodied in or can be included, for example, in a memory card, a memory space connected by way of an external drive, internal RAM or other memory device, or it may take any other suitable form. The memory card includes a non-volatile memory device and processing circuitry. The memory card can be embodied in or can include, for example, an MMC chip card, an SD chip card, a SIM card, or the like.

A DRM validation module 44 is configured to receive DRM data from the mobile movie data area 43. The DRM validation module 44 can control the movie decoder module 41 to allow or disallow it to decode movie data from the mobile movie data area 43 based at least on the DRM data, time/date, serial number inputs, or a combination of the foregoing, as appropriate. When allowed by the DRM validation module 44 to decode movie data from the mobile movie data area 43 and, in some instances, when controlled to do so by user input, the movie decoder module 41 uses the codec 42 to decode the movie data and provide decoded movie data to a buffer 45. From the buffer 45, the movie can be displayed on a display device 46 by a display module 47. The display module 47 can provide control data to the movie decoder module 41 so as to enable decoding at a suitable rate.

In some embodiments, the display device 46 can permit presenting 2D content. For example, the display device 46 can have light emitting diode (LED) screen assembly (in a backlit configuration, for example) having multiple strings of LEDs and a particular number of pixels that defined the resolution of the display device 46. In other examples, the display device 46 can include other types of screen assemblies, such as a liquid crystal display (LCD) screen assembly, a plasma-based screen assembly, an electrochromic screen assembly. or the like.

In other embodiments, the display device 46 can permit presenting a stereographic representation of the decoded movie data. Such a representation can be anaglyphic. In particular, yet not exclusively, the decoded movie data can include first frames and second frames, both types of frames associated with common respective scenes. Specifically, the first frames correspond to respective scenes from a first camera viewpoint (e.g., a “left-eye” images) and the second frames correspond to the respective scenes from a second camera viewpoint (e.g., a “right-eye” images). In such embodiments, the display device 46 can include a screen assembly (LED screen assembly, LCD screen assembly, etc.) that has a first optical assembly that permits presenting the first frames according to a first defined color (e.g., red) and a second optical assembly that permits presenting the second frames according to a second defined color (e.g., cyan). The first defined color can be chromatically opposite to the second defined color. The 2D content presented in the display device 46 can be perceived as 3D content when glasses having appropriate filter are utilized to consume the 2D content.

The technologies described herein are not limited to relying on different colors to produce a 3D perception (or effect). In some implementations, the first optical assembly can permit presenting the first frames according to a first defined light polarization (e.g., first linear polarization or first circular polarization). The second optical assembly can permit presenting the second frames according to a second defined light polarization (e.g., second linear polarization or second circular polarization). Thus, the 2D content presented in the display device 46 can be perceived as 3D content when glasses having appropriate polarized films are utilized to consume the 2D content.

In yet other embodiments, the display device 46 can be a 3D display device that permits presenting a stereographic representation of the decoded movie data. The technologies described herein are not limited to a particular type of 3D display device. Any 3D display device can be utilized in the display device 46. Such a representation can be autostereographic (or glassless 3D). To that end, in some embodiments, the decoded movie data can include first frames and second frames. The first frames correspond to respective scenes from a first camera viewpoint (e.g., a “left-eye” images) and the second frames correspond to the respective scenes from a second camera viewpoint (e.g., a “right-eye” images). The 3D display device includes a parallax screen assembly that has a lighting screen assembly (LED screen assembly, LCD screen assembly, etc.) and a parallax barrier embedded therein. The parallax barrier permits or otherwise facilitates perceiving the first camera viewpoint images with one eye and the second camera viewpoint images with the other eye. Thus, the decoded movie data presented in the display device 46 is perceived as 3D content. In implementations in which more than two camera viewpoints correspond to a scene in the decoded movie data, the parallax barrier can be assembled to permit or otherwise facilitate discerning such several camera viewpoints. Thus, the 3D content can be perceived more readily from a larger span of points of view.

The mobile device 190 may be configured to install a a loader component (e.g., a loader program) from the mobile movie data area 43, if one is stored there. The loader program can then cause the mobile device 190 to determine a configuration of the mobile device 190, and to select a media player. The media player can be a software application and, in some embodiments, can be stored in the mobile movie data area 43. The media player can be used to consume the movie content data. In embodiments in which a suitable media player is already installed in the mobile device 190, then such a movie player can be used instead, and no media player then is installed from the mobile movie data area 43. However, using a proprietary media player stored in the mobile movie data area 43, particularly although not exclusively in the case of the use of a portable storage device (such as an MMC card, a SD card, or a SIM card) can be technically beneficial because it can permit effective control over the security of the content data, and also can permit other features not necessarily available with off-the-shelf or pre-installed media players.

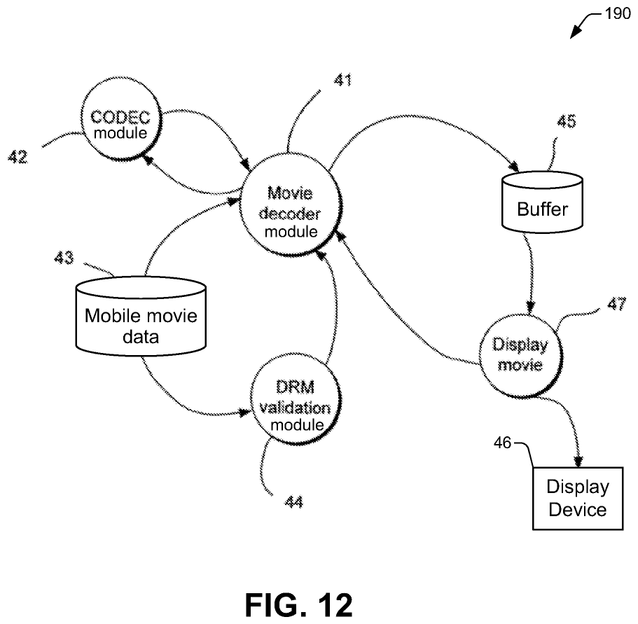

FIG. 13 illustrates a combination of an example of the chip card 150 and the mobile device 190, in accordance with one or more embodiments of this disclosure. As it can be appreciated, FIG. 13 is schematic and details not relevant to the disclosed technologies are omitted for the sake of clarity. As is illustrated, the mobile device 190 includes one or multiple processors 51 that, individually or in a particular combination, can provide video signals to the display device 46, via at least a display driver (not shown), and audio signals to an audio output device 56 (e.g., a headphone socket or speaker) via at least an audio device driver (not shown). A bus architecture 52 can permit or otherwise facilitate sending the video signals and audio signals.

The processor(s) 51 can be arranged in numerous configurations depending at least on the specific type (functionality, operational capacity, etc.) of the mobile device 190. Accordingly, the processor(s) 51 can be embodied in or can constitute a graphics processing unit (GPU); a plurality of GPUs; a central processing unit (CPU); a plurality of CPUs; an ASIC; a microprocessor or another type of digital signal processor; a programmable logic controller (PLC); a FPGA; processing circuitry for executing software instructions or performing defined operations; a combination thereof; or the like. In some embodiments, the processor(s) 51 can be assembled in a single computing apparatus (e.g., an electronic control unit (ECU), and in-car infotainment (ICI) system, or the like). In other embodiments, the processor(s) 51 can be distributed across two or more computing apparatuses (e.g., multiple ECUs; a combination of an ICI system and one or several ECUs; or the like).

The mobile device 190 also includes a radio module 1310 having one or more antennas and a communication processing unit that can permit wireless communication between the mobile device 190 and another device (mobile or otherwise), such as the DRM server device 80.

Each one, or a combination, of the processor(s) 51 is functionally coupled, via the bus architecture 52, to ROM 53, RAM 54, a card connector and interface 55, and other memory 1320. The card connector and interface 55 is suitable for the type of the chip card 150, e.g., an MMC connector and interface, a SD connector and interface, and a SIM housing and interface. The chip card 150 can be connected to the mobile device 190 by means of the connector and interface 55. The memory 1320 can include one or more storage media. In some embodiments, the memory 1320 includes a solid-state memory device and a SIM card. In one of those embodiments, the mobile device 190 can include at least two SIM slots. One of the SIM slots embodies the card connector and interface 55 and can receive a SIM card 150. The other slot is fitted with the SIM card included in the memory 1320. The memory 1320 can include one or more of the codec module 42, the movie decoder module 41, the buffer 45, the DRM validation module 44.

As mentioned, the chip card 150 includes the internal non-volatile memory 154. In some embodiments, the non-volatile memory 154 can have stored thereon, for example, movie content data 57, three different media players 58, and a loader component 59 (such as a loader program). The content data 57 can include 2D content data, 3D content data, or a combination of both. In some embodiments, the content data 57 can include 4D content data (e.g., a combination of 2D content data or 3D content data and sensory metadata). In such embodiments, the mobile device 190 can include one or multiple sensory devices 1330, e.g., haptic devices, lighting devices, heating device, cooling device, a combination thereof, or the like. The sensory device(s) 1330 can be functionally coupled to other component(s) of the mobile device 190 via the bus architecture 52.

When digital content (2D content, 3D content, or 4D content) is required to be reproduced from the chip card 150, the mobile device 190 can load the loader component 59, which can determine which one of the media players 58 is most suitable for reproduction of the content. To that end, for example, the loader component 59 can determine configuration parameters of the mobile device 190 and can compare the configuration parameters to other parameters of the media players 58. One of the media players 58 is then selected based at least on the determination, is loaded onto the mobile device 190, and is executed (e.g., the media player program is processed) to reproduce digital content from the movie content data 57. Operation of the media player 58 can include storing the media player program in the RAM 54 and using the processor(s) 51 to extract relevant data from the chip card 150, to decode the movie content data 57, and to render the resulting content.

Each one of the media players 58 is configured to detect the properties of the display device 46 of the mobile device 190. In particular, yet not exclusively, a media player 58 can detect the display dimensions and orientation, in terms of numbers of pixels in height and width. The media player 58 also is configured to control reproduction of the video content on the display device 46 in an orientation which is most suited to the mobile device 190. If the display device 46 is wider than it is high, then video content can be reproduced with conventional orientation, e.g., without its orientation being modified. However, if the display device 46 is determined to be higher than it is wide, the media player 58 can cause reproduction of the video content rotated by 90 degrees. Thus, the media player 58 can ensure that the video content always is reproduced in landscape format (wider than tall) regardless of screen dimensions. This can allow more effective use of the display area of the display device 46.

When the video content is rotated on the display device 46 by a media player 58, the functions of a number of keys on a keypad (not shown) or another input device are caused by the media player 58 to be modified so as to be different than their functions when the video content is not rotated by the media player 58. Since the mobile device 190 will need to be rotated onto its side before the video can be viewed in its intended orientation, providing different key functions with different orientations allows the same control experience to be provided to a user regardless of the orientation of the mobile device 190. Thus, modifying the controls can permit control of the media player using the keypad or another input device to be more convenient and more intuitive for a user. Controls that can be of particular importance are volume up, volume down, play, pause, forward, and rewind, etc.

In embodiments in which the mobile device 190 is not a high specification device, e.g., the mobile device 190 has relatively low content handling capability and/or a low-resolution display, a media player 58 can be configured such that the media player 58 can access content data 57 from the chip card 150 (e.g., an MMC chip card, a SD chip card, a SIM card, or the like) and not access content from other sources. This allows the content data 57 on the example chip card 150 to be optimized for reproduction by the media player 58 (a proprietary media player, for example) thus providing richer content reproduction than would otherwise be available considering memory size and other technical limitations of the chip card 150. This feature does not prevent of the media player 58 to use a standard codec (such as CODEC module 42) included in the mobile device 190. Indeed, the media player 58 may utilize standard or other third-party CODEC modules, or the media player 58 may utilize a proprietary CODEC module.

In embodiments in which the mobile device 190 is higher specification mobile devices, a different media player 58 can be executed. Here, the media player 58 selected by the loader component 59 can be configured to scale non-optimal content for satisfactory presentation (e.g., best presentation, second best presentation, etc.).

In addition, or as an alternatively, one media player 58 which has adjustable functionality can be provided on the chip card 150. Such a media player 58 does not require the loader component 59. When executing on the mobile device 190, this media player 58 can detect the relevant characteristics of the mobile device 190. Thus, this media player 58 can activate appropriate components and functionality of the media player 58 and can refrain from activating other components and functionality.

In one embodiment, the hardware of the chip card 150 may be, for example, any of the SD forms that currently are available. Accordingly, the SD hardware includes a flash memory device and a memory/interface controller residing on a thin printed circuit board (PCB) in a very low-profile plastic housing. The underside of the P′CB can form the underside of the housing. In such an embodiment, the chip card 150 can have one of a number of different form factors. The SD forms can include SD standard card, miniSD, and microSD.

In some embodiments, the hardware of the chip card 150 includes numerous security features. As such, the chip card 150 can embody, for example, a secure MMC chip card, a secure SD chip card, or a SIM card. In such embodiments, at least one of the media players 58 can be embodied in or can include a proprietary media player and can be used to unlock and read content on the secure chip card.

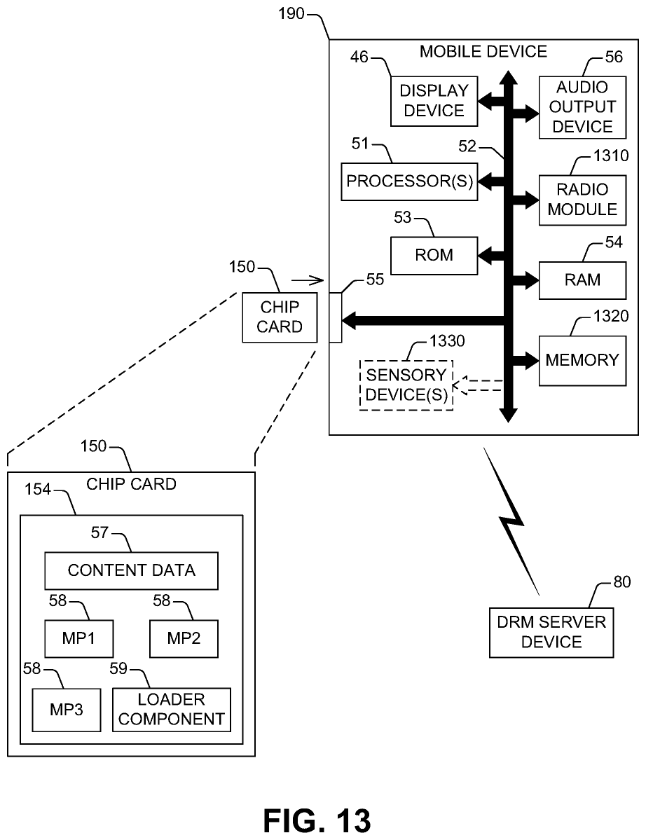

FIG. 14 illustrates an example of a chip card 150 that includes security elements, in accordance with one or more embodiments of this disclosure. The chip card 150 includes a housing 60 having multiple connector pins 61. The connector pins 61 form part of a host communications interface to an external device, such as the mobile device 190. The chip card 150 also includes one or more non-volatile (NV) memory devices 62 (referred to as NV memory 62). The NV memory 62 can be connected to a memory and interface controller 63 that controls access to the NV memory 62 and interfaces to the connector pins 61.

The chip card 150 also includes a security device 64. The security device 64 may be implemented as a microcontroller, an ASIC or an FPGA. The components of the chip card 150 shown in FIG. 13 can be mounted onto a PCB that forms part of the housing 60. In some embodiments, the chip card 150 may have the same dimensions and the same external connectors as a conventional MMC card.

As is illustrated in FIG. 14, the security device 64 is interposed between the memory and interface controller 63 and the multiple connector pins 61. Thus, in some embodiments, the memory and interface controller 63 and data (DAT), command (CMD) and clock (CLK) lines of the multiple connector pins 61 are not connected directly. At least some connection between these components is via the security device 64. In turn, VCC, VSS1 and VSS2 lines of the multiple connector pins 61 are connected to both the security device 64 and the memory and interface controller 63 in parallel.

Accordingly, the security device 64 is arranged to intercept data and commands communicated between the host device, e.g. the mobile device 190, and the memory and interface controller 63. This intercepted data can be processed and either can be passed through the security device 64 modified or unmodified. Alternatively, the intercepted data is replaced by data generated by the security device 64.

Specific data or commands passed in any response can switch the security device 64 into an active mode. In the active mode, the security device 64 can read from or can write to one of the memory and interface controller 63 or the host interface 61, masquerading as the other one of those devices. In the active mode, the security device 64 also independently, e.g., without external control, interrogates the memory and interface controller 63 and either prepares data for subsequent host requests or writes data to the NV memory 62 for subsequent requests.

The provision of the active mode allows copy protection to be achieved through cooperation between the chip card 150 and a media player 58.

In some instances, the security device 64 does not restrict access to regions of the non-volatile memory 62 where unprotected content resides, in both read and write modes. This allows the chip card 150 including the security device 64 to be used without the security features provided by the security device 64 being operational. The security device 64 can be activated only by authorized entities, such as those licensed to place copyright content (e.g., 2D movies, 3D movies, or 4D movies) onto the chip card 150. The chip card 150 and a media player 58 can be provided with the same serial number.

During configuration, the media player 58 is provided also with the result of application of the serial number to a hash function, hereafter termed the hash of the serial number. The memory and interface controller 63 can be controlled by the security device 64 to store at programming time (e.g., when it is programmed before sale) the serialized data serial number, a preconfigured security code, and the hash of the serial number.

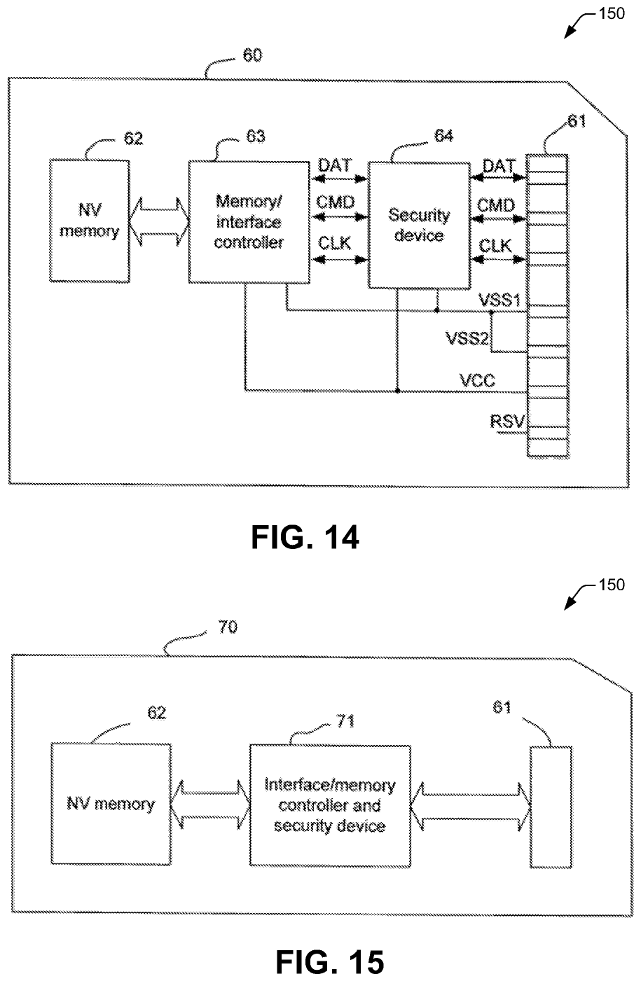

Validation of the chip card 150 by the media player 58 and validation of the media player 58 by the chip card 150 will now be described with reference to FIG. 16.

When a chip card 150 having digital content (2D content, 3D content, 4D content, or a combination thereof) one or more media players 58 and optionally a loader component 59 loaded onto the chip card 150 is connected with a mobile device 190, the media player(s) 58 can be made visible in a menu thereof. Thus each one of the media player(s) 58 becomes able to be activated as with any other software application present on the mobile device 190. When a media player 58 first is started, a first security validation can be implemented, in which the following occurs. Firstly, the most suitable media player 58 of the one or more media players 58 is uploaded to the mobile device 190. At block 1605, the uploaded media player 58 can send the hash of the serial number to the security device 64.

At block 1610, the security device 64 can then compare the received hash of the serial number with its internally stored hash of the serial number. At block 1615, the security device 64 can determine if the comparison reveals a match. In response to a positive determination, it is initially assumed that the media player 58 and the chip card 150 are matched, and the security device 64 unlocks the chip card 150 at block 1620. At block 1625, the security device 64 can send a reconfigured validation code to the media player 58. Alternatively, in response to a determination that the comparison at block 1610 does not reveal a match, the security device 64 does not respond, as is shown at block 1630.

When the media player 58 receives the validation code, the media player 58 can perform a 32-bit cyclic redundancy check (CRC) calculation on the validation code at block 1635. Based at least on an outcome of this calculation, the media player 58 can determine whether the chip card 150 is the one associated with the media player 58 at block 1640. In response to a positive determination, the media player 58 can unlock the media player 58 at block 1645. In the alternative, in response to a negative determination, the media player 58 can abort with an error message at block 1650. At this stage, the media player 58 can read data from unprotected areas on non-volatile memory 62, FIG. 14, if any such areas are present.

A second stage security check is performed when playing the content. After the media controls on the chip card 150 are unlocked and the data becomes readable, data can be read out from the non-volatile memory 62 to the media player 58. Essentially in parallel with this, at block 1655, the security device 64 can set a data stream into frames of 1 kB (1000 bytes between frame start and end points) for example. At block 1660, the media player 58 can calculate the security code (as is described in more detail below) and can then send the security code to the security device 64. In turn, at block 1665, the security device 64 can decode the security code.

Based at least on the decoding, at block 1670, the security device 64 can determine if the security code is valid. If invalid, the security device 64 can reset a timeout counter at block 1675, thereby preventing a timeout occurring and locking the content. If valid, at block 1680, the security device 64 can clear reset data frame for play. A memory and interface controller 63, FIG. 14, can consider the subsequent data frame as being validated for access. If a valid code is not received before the end of this frame, subsequent frames can be filled with random data instead of content data.

At block 1685, the media player 58 can recalculate the correct security code once in every frame. To that point, in one embodiment, the media player 58 can generate M (e.g., 20) security codes for each data frame, M−1 (e.g., 19) of which are incorrect. The media player 58 also can send the chip card 150 all the security codes at block 1685, in such an embodiment resulting in M security codes being sent for every frame of data. M−1 of these security codes are intentionally incorrect and only one of the security codes is correct. The security device 64 of the chip card 150 can compare the results of its calculations with the security code sent by the media player 58.

The security device 64 allows content data to be sent to the media player 58 as long as one correct security code is received in every frame. If the security device 64 detects that a valid security code has not been received for a predetermined period of time, using a timer, or if too few codes (either correct or incorrect) are received, then the security device 64 can disable access to the data in the non-volatile memory 62. The security device 64 then needs to be unlocked again by the media player 58 before content playback can be resumed. The security device 64 also can lock the chip card 150 if the chip card 150 has not been accessed for a predetermined, configurable period of time.

In some embodiments, a security code in accordance with this disclosure is calculated based at least on one type or a combination of the following types of data: CRC−the last 4 bytes of the decoded validation code (the checksum part). Bytes−the total number of bytes read from the chip card 150 so far. Random−a number between 0 and M/2, which is one half of the number of security updates per frame (e.g., 10 is half of the 20 updates per frame that there are).

As an example, the media player 58 performs the calculation: ((CRC<<Mod 32(Bytes)) XOR (Bytes))*Random. This means that the checksum part (CRC) of the validation code is shifted left by a modulo 32 of the number of bytes read. The result is XOR-ed with the number of bytes read. The XOR operation includes applying corresponding bits in the two numbers to respective exclusive-OR gates. The result is multiplied by the random number Random.

Continuing with the foregoing example, the security device 64 in the chip card 150 performs the calculation: ((CRC<<Mod 32(Bytes)) XOR (Bytes))*Modulo frame size(frame number) o Modulo frame size(frame number) is frame number modulo 1000 in this instance because the frame size may change, i.e. 1000 e.g. 5032 becomes 0032.

Regardless the specific fashion in which security codes are determined, the result of the example technique shown in FIG. 16 is the continual validation of the media player 58 by the security device 64 of the chip card 150. Such validation prevents the use of a false media player to extract the content data in a useable form from the chip card 150. Instead, the content data can only be extracted from the chip card 150 by a validated (or legitimate) media player 58. The validated media player 58 can render the content data for consumption but does not allow the content data to be used to provide unauthorized copies. The fact that the media player 58 sends many incorrect codes makes it difficult, if not impossible, to determine from examination of the security codes sent from the media player 58 to the chip card 150 what calculation is needed to determine the correct codes, thus increasing security since the difficulty of making a false media player which could extract data from the chip card 150 is significantly increased.

Using these features, the security device 64 is configured to determine whether an external device (e.g., the mobile device 190 executing a media player 58) is entitled to access content data from the non-volatile memory 62 and to allow or disallow access to the content data accordingly.

FIG. 15 illustrates another example of a chip card 150 (e.g., a MCC chip card, a SD chip card, or a SIM card) that includes security elements, in accordance with one or more embodiments of this disclosure. Here, the memory and interface controller 63 is omitted. Instead, a combined memory and interface controller and security device 71 connects the non-volatile memory 62 with the multiple connector pins 61.

Such an arrangement provides the same functionality that the memory and interface controller 63 and the security device 64 do together, but with some additional functionality, as is explained below. Such an embodiment of the chip card 150 has an advantage over other embodiments in that it provides a more compact form factor than a chip card 150 according to FIG. 14. Therefore, the chip card 150 shown in FIG. 15 could be included within a smaller housing than that of other chip cards disclosed herein. Since it has less hardware, the chip card 150 according to FIG. 15 may also be less expensive to manufacture. Also, the combined memory and interface controller and security device 71 does not need to support the same type of non-volatile memory as an MMC controller, thereby providing component flexibility.

The combined memory and interface controller and security device 71 can emulate the host interface of a standard MMC controller, so as to allow full connectivity with host devices, such as the mobile device 190. The combined memory and interface controller and security device 71 also can support additional host interface commands to support security configuration and security validation in some specific hosts. The combined memory and interface controller and security device 71 can encrypt all data written to the non-volatile memory 62, and can decrypt all data read from the non-volatile memory 62. Thus, data accessed by the mobile device 190 is not read from the non-volatile memory 62 directly; instead it is decrypted, processed, and buffered in the combined memory and interface controller and security device 71.

Some data accessed by a host device is a result of processing, for example the security device 64 can compile information for subsequent host requests, or its status information, e.g. security status information, which the media player 58 can use to re-validate security or to inform the user of the nature of a problem The combined memory and interface controller and security device 71 can be implemented by a microcontroller, an ASIC or an FPGA.

With the chip cards illustrated in both FIG. 14 and FIG. 15, DRM information can be stored in a DRM file within an area of the non-volatile memory 62 which has been defined as a secure area during configuration of the chip card 150. A media player 58 can read the DRM file but cannot influence it, except in the case of a time specific DRM matter. Either one of the security device 64 or the device 71 can be arranged to count the number of times that content is played in a mobile device coupled to the chip card 150. If the content is only partially played, this is counted as a play of the content. The number of times that the content has been played can be recorded in the DRM file by the security device 64 or the device 71. This information can be read by, but cannot be not influenced by, the media player 58. The DRM file indicates a maximum number of occasions in which the content data can be played back.

The DRM data included in the DRM file also can include a timeout date or validity date for the content. When the media player 58 is first started, it cooperates with the security device 64 or the device 71 to write the current time and date of the mobile device 190 from its internal clock (not shown) into the DRM file. If playback of the content is requested and the security device 64 or device 71 determines that the latest time and date at which the content could be played has expired (e.g., the current time and date is later than the time/date first recorded plus the validity period), the security validation between the security device 64 or the device 71 and the media player 58 fails. As a result, the display device 46 can present an appropriate message. The same or similar response occurs if the limit of the number of occasions on which the content data can be played back is reached.

The security device 64 or the device 71 also can write to the DRM file data identifying that the content has expired. If after the content has expired once and the time/date of the mobile device 190 is changed to a value that precedes the expiration time/date of the content, the security device 64 or the device 71 can detect such a change by detecting data identifying that the content has previously expired in the DRM file. In this case, a predetermined number of further plays of the content, for example five (5) plays, can be allowed before the content becomes locked requiring a DRM unlock. This can be achieved using on-line validation. This feature can ease the user impact if the clock in the mobile device was incorrectly configured when the media player 58 was first started.

With reference to FIG. 5, in some embodiments, an on-line validation process can begin with the media player 58 connecting to a DRM server 80. An entity that is licensed to render content onto MMCs can own or administer the DRM server 80, for example. The DRM server 80 can have information indicative of the configuration of every chip card 150 that has been released. Connection may be made through WAP, short message service (SMS), multimedia messaging service (MMS), or in any other suitable way. If the DRM information on the DRM server 80 is valid, the DRM server 80 sends a code through the media player 58 to the security device 64 or the device 71. The code causes the media player 58 to be validated and thus unlocks the content for further playback. This involves updating the DRM file. Locked content can be unlocked again by payment for further content access through a variety of channels (web, WAP (e.g. Bango), SMS, and MMS).

If content on a chip card 150 od this disclosure is locked, the media player 58 cannot play back content data. In this case, the user of the mobile device 190 may arrange for the content to be unlocked for further playback, for example by making an additional payment. This can occur in any suitable way, for example using WAP, a web-based payment service, or by negotiating with an operator by telephone. When payment is made, the DRM server 80 can be updated with this information. When the media player 58 is subsequently started and attempts to access the locked content, the media player 58 contacts the DRM server 80, in any suitable way. In response, the DRM server 80 can send an unlocking code to the mobile device 190 which the media player 58 passes to the security device 64 or the device 71. The security device 64 or device 71 then validates the unlocking code, and updates the DRM file to unlock the content.

Although in some embodiments the mobile device 190 can be a mobile telephone, the mobile device 190 may be embodied in another types of device having wireless communication functionality. For example, the mobile device 190 can be embodied in a personal digital assistant (PDA), which may or may not have bidirectional voice communication capabilities. Regardless the specific type of the mobile device 190, the technologies disclosed herein permit, individually or in combination, providing audiovisual content on a mobile device that is designed primarily for another function besides voice and data communication or that is embodied in a dedicated media player.

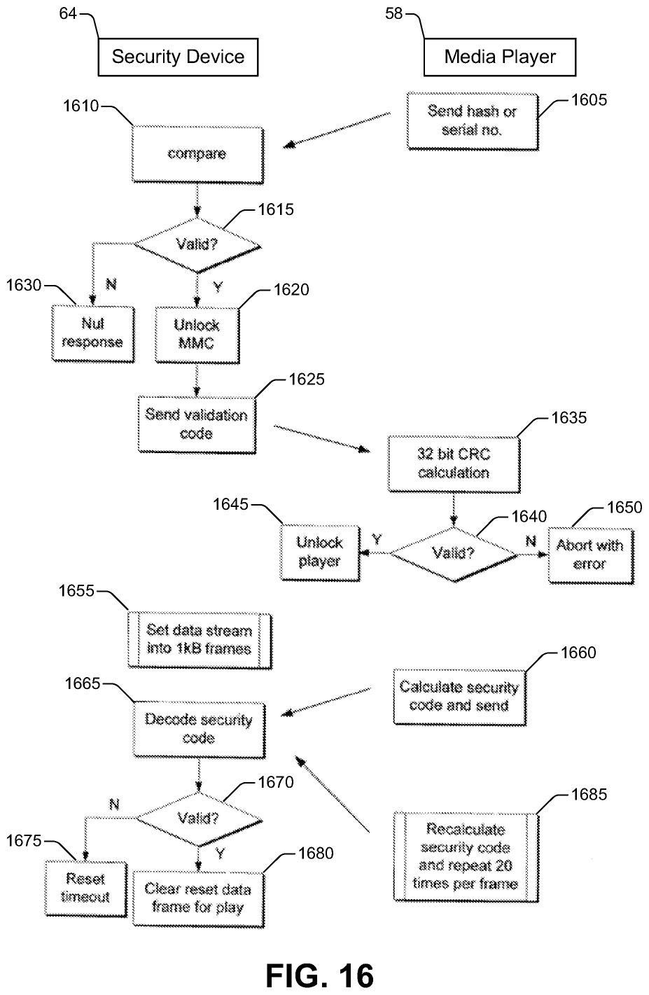

Also, although some aspects of the technologies of this disclosure have been described in relation to the chip card 150, the technologies disclosed herein are not limited in that respect. Indeed, the principles and practical elements of the technologies disclosed herein can be applied to other types of storage devices including non-volatile memory and an internal memory controller with access to content data stored on the non-volatile memory being obtained through an interface. For example, a memory device with a USB or Bluetooth™ or another type of interface could be used instead. The housing of the memory device may take any suitable form.

Where a movie on a DVD or a BD is to be provided onto a chip card (e.g., a MMC chip card, a SD card, a SIM card) or other type of transferable non-transitory media for use with a general class of target mobile devices, or even where the movie is to be provided for more than a small number of target devices on the same model number, a system such as a system 1700 as is illustrated in FIG. 17 can be used to advantage. The system 1700 includes a first server device 30, a second server device 31, and a third server device 32. The first server device 30 can be designated as a management node, and includes connections to each one of the second server device 31 and the third server device 32, which devices can be designated as child nodes. Each one of the server devices 30 to 32 can include at least a first optical disc drive (ODD) 33 and a second optical disc drive (ODD) 33. In some embodiments, each one of the first ODD 33 and the second ODD 33 is embodied in a DVD drive. In one example, DVDs can be inserted into and extracted from the DVD drives 33 manually, although it is possible to use robots or other automation for this task instead if required. In other embodiments, each one of the first ODD 33 and the second ODD 33 is embodied in a BD drive.

Each one of the server devices 30 to 32 can extract and can convert movies from suitable optical discs (DVDs or BDs, for example) in the ODD drives 33 in parallel. Movies can be extracted from suitable optical discs (DVDs or BDs, for example) in a single drive sequentially, e.g., one after the other.

In example scenarios having sufficient speed for the ODD drive 33 and sufficient processing speed for the server devices 30 to 32, the process of extraction and conversion of digital content from an optical disc (e.g., a DVD or BD) can be completed in tens of minutes. Thus, where a serial number of a target mobile device or similar is to be included in the resulting movie to enable the movie to be reproduced only on that target mobile device, the conversion process can be performed once for each specific target mobile device. Such an extraction process can be performed only once, since the extracted movie is stored in the extracted movie data area 14, FIG. 4.

Where a movie is to be used for a number of target mobile devices of the same class, then the extraction and conversion processes can be performed only once. Upon storing the movie, or after the movie is stored, in mobile format in the mobile format movie data area 20, digital content corresponding to the movie can be generated and written to an MMC chip card, a SD chip card, a SIM card, or other removable media device as many times is required. This can be carried out in a suitable manner, for example using internal or external MMC drives, SD drives, or other types of appropriate drives.

In some embodiments, a setup for the management system installation specific architecture can be in flat files, for example, in a /etc/ subdirectory. The setup for movie production can be in database tables using a custom Postgres or Oracle database, for example. Any other suitable database can be used instead, depending on the scale and performance requirements. The management system running on the child node server devices 31, 32 can communicate with the management system on the management node server device 30. The management node server device 30 can implement task allocation or another type of scheduling. One instance of the management system may be required for each conversion session.

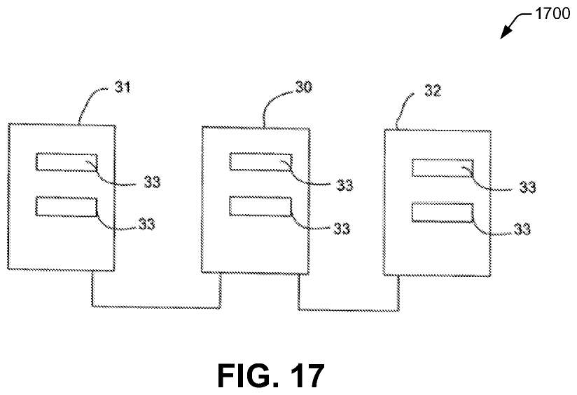

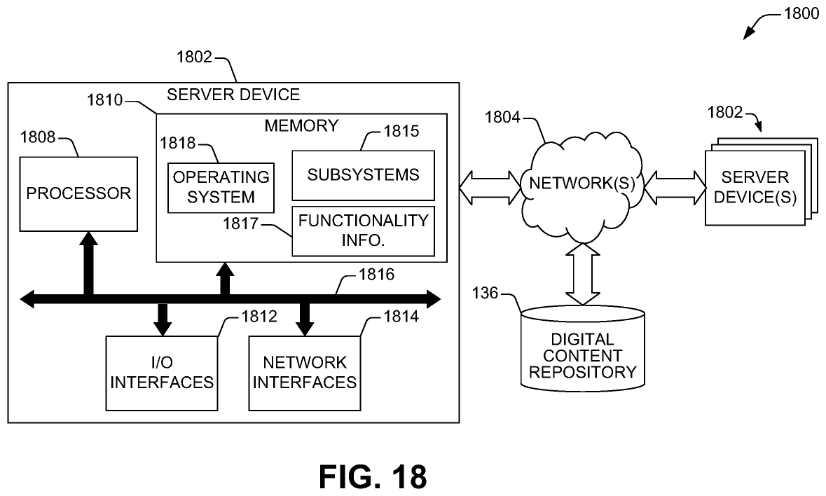

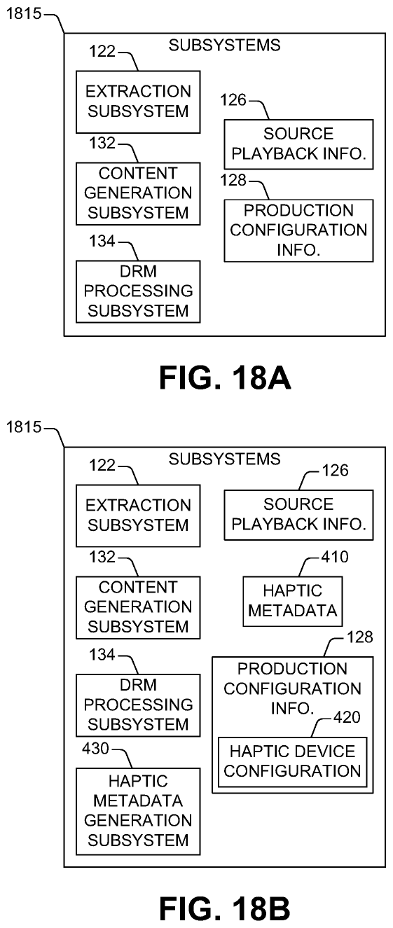

FIG. 18 illustrates an example of a computing environment 1800 that includes examples of multiple server devices 1802 mutually functionally coupled by means of one or more networks 1804, such as the Internet or any wireline or wireless connection. In some embodiments, a combination of a single server device 1802 and the digital content repository 136 can embody or can constitute a content provision apparatus 120 in accordance with aspects of this disclosure (see FIG. 1, FIG. 7). In other embodiments, a combination of a group of networked server devices 1802 and the digital content repository 136 can embody or can constitute a content provision apparatus 120 in accordance with aspects of this disclosure.

Each one of the server devices 1802 can be a digital computer that, in terms of hardware architecture, can include one or more processor 1808 (generically referred to as processor 1808), one or more memory devices 1810 (generically referred to as memory 1810), input/output (I/O) interfaces 1812, and network interfaces 1814. These components (1808, 1810, 1812, and 1814) are communicatively coupled via a communication interface 1816. The communication interface 1816 can be embodied in or can include, for example, one or more bus architectures or other wireline or wireless connections.

The bus architecture(s) can be embodied in, or can include, one or more of several types of bus structures, including a memory bus or a memory controller, a peripheral bus, an accelerated graphics port, and a processor or local bus using any of a variety of bus architectures. As an illustration, such architectures can include an ISA bus, an MCA bus, an EISA bus, a VESA local bus, an AGP bus, a PCI bus, a PCI-Express bus, a PCMCIA bus, a USB, a combination thereof, or the like. In addition, or in some embodiments, at least one of the bus architecture(s) can include an industrial bus architecture, such as an Ethernet-based industrial bus, a CAN bus, a Modbus, other types of fieldbus architectures, or the like.

Further, or in yet other embodiments, the communication interface 1816 can have additional elements, which are omitted for simplicity, such as controller device(s), buffer device(s) (e.g., cache(s)), drivers, repeaters, transmitter device(s), and receiver device(s), to enable communications. Further, the communication interface 1816 may include address, control, and/or data connections to enable appropriate communications among the aforementioned components.

The processor 1808 can be a hardware device that includes processing circuitry that can execute software, particularly that stored in the memory 1810. In addition, or as an alternative, the processing circuitry can execute defined operations besides those operations defined by software. The processor 1808 can be any custom made or commercially available processor, a central processing unit (CPU), a graphical processing unit (GPU), an auxiliary processor among several processors associated with the server device 1802, a semiconductor-based microprocessor (in the form of a microchip or chipset), or generally any device for executing software instructions or performing defined operations. When the server device 1802 is in operation, the processor 1808 can be configured to execute software stored within the memory 1810, for example, in order to communicate data to and from the memory 1810, and to generally control operations of the server device 1802 according to the software.

The I/O interfaces 1812 can be used to receive user input from and/or for providing system output to one or more devices or components. User input can be provided via, for example, a keyboard, a touchscreen display device, a microphone, and/or a mouse. System output can be provided, for example, via the touchscreen display device or another type of display device. I/O interfaces 1812 can include, for example, a serial port, a parallel port, a Small Computer System Interface (SCSI), an infrared (IR) interface, a radiofrequency (RF) interface, and/or a universal serial bus (USB) interface.

The network interface 1814 can be used to transmit and receive data, metadata, and/or signaling from an external server device 1802, the digital content repository 136, and other types of external apparatuses on one or more of the network(s) 1804. The network interface 1814 may include, for example, a 10BaseT Ethernet Adaptor, a 100BaseT Ethernet Adaptor, a LAN PHY Ethernet Adaptor, a Token Ring Adaptor, a wireless network adapter (e.g., WiFi), or any other suitable network interface device. The network interfaces 1814 may include address, control, and/or data connections to enable appropriate communications on the network(s) 1804.

The memory 1810 can include any one or combination of volatile memory elements (e.g., random access memory (RAM, such as DRAM, SRAM, SDRAM, etc.)) and non-volatile memory elements (e.g., ROM, hard drive, tape, CDROM, DVDROM, etc.). The memory 1810 also may incorporate electronic, magnetic, optical, and/or other types of storage media. In some embodiments, the memory 1810 can have a distributed architecture, where various storage devices are situated remotely from one another, but can be accessed by the processor 1808.

Software that is retained in the memory 1810 may include one or more software components, each of which can include, for example, an ordered listing of executable instructions for implementing logical functions in accordance with aspects of this disclosure. As is illustrated in FIG. 18, the software in the memory 1810 of the server device 1802 can include a group of the subsystems 1815 and an operating system (0/S) 1818. The 0/S 1818 essentially controls the execution of other computer programs and provides, amongst other functions, scheduling, input-output control, file and data management, memory management, and communication control and related services.

The memory 1810 also retains functionality information 1817 (e.g., data, metadata, or a combination of both) that, in combination with the group of subsystems 1815, can permit or otherwise facilitate the generation of digital content (e.g., 2D content, 3D content, 4D content, or a combination of the foregoing) for reproduction on at mobile device, in accordance with aspects of this disclosure. The functionality information 1817 can include, for example, source playback information; production configuration information; sensory metadata; a combination thereof; or the like.

As an illustration, application programs and other executable program components, such as the O/S 1818, are illustrated herein as discrete blocks, although it is recognized that such programs and components can reside at various times in different storage components of the server device 1802. An implementation of the subsystems 1815 can be stored on or transmitted across some form of computer-readable storage media. One example of such an implementation is illustrated in FIG. 18A where a group of the subsystems 1815 can form a defined software architecture that includes the extraction subsystem 122, the content generation subsystem 132, and the DRM processing subsystem 134. The subsystems of the software architecture illustrated in FIG. 18A can be executed, by the processor 1808, for example, to generate digital content in accordance with one or more embodiments of the disclosure. Another example of such an implementation is illustrated in FIG. 18B where the group of the subsystems 1815 can form a defined software architecture that includes the extraction subsystem 122, the content generation subsystem 132, and the DRM processing subsystem 134, and the haptic metadata generation subsystem 430. The subsystems of the software architectures illustrated in FIG. 18B can be executed, by the processor 1808, for example, to generate digital content in accordance with one or more embodiments of the disclosure. While the subsystems that constitute the respective software illustrated in FIG. 18A and FIG. 18B are illustrated as discrete separate blocks, the disclosure is not limited in that respect. Indeed, the functionality of each those software architectures also can be achieved with other arrangements of the illustrated subsystems.

Any of the disclosed methods can be performed by computer-accessible instructions (e.g., computer-readable instructions and computer-executable instructions) embodied on computer-readable storage media. Computer readable media can be any available media that can be accessed by a computer. By way of example and not meant to be limiting, computer readable media can comprise “computer storage media” and “communications media.” “Computer storage media” can include volatile media and non-volatile media, removable media and non-removable media implemented in any methods or technology for storage of information such as computer-readable instructions, computer-executable instructions, data structures, program modules, or other data. Examples of computer-readable non-transitory storage media can comprise RAM; ROM; EEPROM; flash memory or other memory technology; CD-ROM; DVDs, BDs, or other optical storage; magnetic cassettes; magnetic tape; magnetic disk storage or other magnetic storage devices; or any other medium or article that can be used to store the desired information and which can be accessed by a computing device.

As used in this application, the terms “environment,” “system,” “module,” “component,” “interface,” and the like refer to a computer-related entity or an entity related to an operational apparatus with one or more defined functionalities. The terms “environment,” “system,” “module,” “component,” and “interface” can be utilized interchangeably and can be generically referred to functional elements. Such entities may be either hardware, a combination of hardware and software, software, or software in execution. As an example, a module can be embodied in a process running on a processor, a processor, an object, an executable portion of software, a thread of execution, a program, and/or a computing device. As another example, both a software application executing on a computing device and the computing device can embody a module. As yet another example, one or more modules may reside within a process and/or thread of execution. A module may be localized on one computing device or distributed between two or more computing devices. As is disclosed herein, a module can execute from various computer-readable non-transitory storage media having various data structures stored thereon. Modules can communicate via local and/or remote processes in accordance, for example, with a signal (either analogic or digital) having one or more data packets (e.g., data from one component interacting with another component in a local system, distributed system, and/or across a network such as a wide area network with other systems via the signal).

As yet another example, a module can be embodied in or can include an apparatus with a defined functionality provided by mechanical parts operated by electric or electronic circuitry that is controlled by a software application or firmware application executed by a processor. Such a processor can be internal or external to the apparatus and can execute at least part of the software or firmware application. Still in another example, a module can be embodied in or can include an apparatus that provides defined functionality through electronic components without mechanical parts. The electronic components can include a processor to execute software or firmware that permits or otherwise facilitates, at least in part, the functionality of the electronic components.

In some embodiments, modules can communicate via local and/or remote processes in accordance, for example, with a signal (either analog or digital) having one or more data packets (e.g., data from one component interacting with another component in a local system, distributed system, and/or across a network such as a wide area network with other systems via the signal). In addition, or in other embodiments, modules can communicate or otherwise be coupled via thermal, mechanical, electrical, and/or electromechanical coupling mechanisms (such as conduits, connectors, combinations thereof, or the like). An interface can include input/output (I/O) components as well as associated processors, applications, and/or other programming components.

As is utilized in this disclosure, the term “processor” can refer to any type of processing circuitry or device. A processor can be implemented as a combination of processing circuitry or computing processing units (such as CPUs, GPUs, or a combination of both). Therefore, for the sake of illustration, a processor can refer to a single-core processor; a single processor with software multithread execution capability; a multi-core processor; a multi-core processor with software multithread execution capability; a multi-core processor with hardware multithread technology; a parallel processing (or computing) platform; and parallel computing platforms with distributed shared memory.

Additionally, or as another example, a processor can refer to an integrated circuit (IC), an ASIC, a digital signal processor (DSP), an FPGA, a PLC, a complex programmable logic device (CPLD), a discrete gate or transistor logic, discrete hardware components, or any combination thereof designed or otherwise configured (e.g., manufactured) to perform the functions described herein.

Further, in the present specification and annexed drawings, terms such as “store,” “storage,” “data store,” “data storage,” “memory,” “repository,” and substantially any other information storage component relevant to the operation and functionality of a component of this disclosure, refer to memory components, entities embodied in one or several memory devices, or components forming a memory device. It is noted that the memory components or memory devices described herein embody or include non-transitory computer storage media that can be readable or otherwise accessible by a computing device. Such media can be implemented in any methods or technology for storage of information, such as machine-accessible instructions (e.g., computer-readable instructions and/or computer-executable instructions), information structures, program modules, or other information objects.

While the technologies (e.g., systems, apparatuses, techniques, computer program products, and devices) of this disclosure have been described in connection with various embodiments and specific examples, it is not intended that the scope be limited to the particular embodiments put forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. An apparatus, comprising:
at least one memory device having stored thereon computer-executable components; and
at least one processor functionally coupled to the at least one memory device and configured to execute the computer-executable components at least to,
access production configuration information indicative of a configuration for digital content reproduction at a mobile device;
access digital content from a storage assembly including at least one non-transitory storage medium;
access reproduction information for the digital content from the storage assembly;
generate second digital content using at least one of the reproduction information, the digital content, or the production configuration information, wherein the second digital content is configured for presentation in a stereoscopic three-dimensional (3D) display device

2. The apparatus of claim 1, the at least one processor further configured to execute the computer-executable components to output the second digital content to a chip card including a non-volatile memory device and a processing unit.

3. The apparatus of claim 2, wherein the chip card is one of a Subscriber Identification Module (SIM) card or a Secure Digital (SD) memory card having processing circuitry.

4. The apparatus of claims 2, wherein the storage assembly includes a media drive that receives a first non-transitory storage medium of the at least one non-transitory storage medium, and wherein the first non-transitory storage medium is one of a digital versatile disc (DVD) or a Blu-ray disc (BD).

5. The apparatus of claims 2, wherein the storage assembly includes at least one storage device having the at least one non-transitory storage medium, a first storage device of the at least one storage device is one of a hard disk drive (HDD) or a solid-state drive (SDD).

6. The apparatus of claim 2, the at least one processor further configured to execute the computer-executable components to output, to the non-volatile memory device of the chip card, sensory metadata to control sensory effects during reproduction of the second digital content at a mobile device.

7. The apparatus of claim 1, the at least one processor further configured to execute the computer-executable component to generate metadata to control haptic effects during playback of the second digital content.

8. The apparatus of claim 7, to generate the metadata, the at least one processor further configured to execute the computer-executable components to, access configuration information indicative of devices available to implement haptic effects;
determine, using the digital contend, a group of haptics effects compatible with the configuration information;
generate data indicative of the group of haptic effects.

9. The apparatus of claim 8, the at least one processor further configured to execute the computer-executable components to configure the data according to a format to control the haptic effects during the playback of the second digital content, the assembled data resulting in the metadata.

10. A method, comprising:
receiving production configuration information indicative of a configuration for digital content reproduction at a mobile device;
receiving digital content from a storage assembly including at least one non-transitory storage medium;
receiving reproduction information for the digital content from the storage assembly;
generating second digital content using at least one of the reproduction information, the digital content, or the production configuration information, wherein the second digital content is configured for presentation in a stereoscopic three-dimensional (3D) display device.

11. The method of claim 10, further comprising outputting the second digital content to a non-volatile memory device of a memory card having processing circuitry.

12. The method of claim 11, further comprising outputting, to the non-volatile memory device, sensory metadata to control sensory effects during reproduction of the second digital content at a mobile device.

13. The method of claim 10, further comprising generating haptic metadata to control haptic effects during reproduction of the second digital content at a mobile device at a mobile.

14. The method of claim 13, wherein the generating the haptic metadata comprises,
receiving information indicative of a group of devices available to implement haptic effects at a mobile device;
determining, using the digital content, a group of haptic effects compatible with at least one haptic device of the group of haptic devices;
generating data indicative of the group of haptic effects.

15. The method of claim 14, further comprising configuring the data according to a format to control the group of haptic effects during the reproduction of the second digital content, the configured data resulting in the haptic metadata.

16. At least one computer-readable non-transitory storage medium having instructions stored thereon that, in response to execution, cause at least one processor to perform or facilitate operations comprising:
receiving production configuration information indicative of a configuration for digital content reproduction at a mobile device;
receiving digital content from a storage assembly including at least one non-transitory storage medium;
receiving reproduction information for the digital content from the storage assembly;
generating second digital content using at least one of the reproduction information, the digital content, or the production configuration information, wherein the second digital content is configured for stereoscopic presentation on display device of the mobile device.

17. The at least one computer-readable non-transitory storage medium of claim 16, the operations further comprising outputting the second digital content to a non-volatile memory device of a memory card having processing circuitry.

18. The at least one computer-readable non-transitory storage medium of claim 17, the operations further comprising outputting, to the non-volatile memory device, sensory metadata to control haptic effects during reproduction of the second digital content at a mobile device.

19. The at least one computer-readable non-transitory storage medium of claim 16, the operations further comprising generating haptic metadata to control haptic effects during reproduction of the second digital content at a mobile device at a mobile.

20. The at least one computer-readable non-transitory storage medium of claim 19, wherein the generating the haptic metadata comprises,
receiving information indicative of a group of devices available to implement haptic effects at a mobile device;
determining, using the digital content, a group of haptic effects compatible with at least one haptic device of the group of haptic devices;
generating data indicative of the group of haptic effects.
